(19) United States
(12) Patent Application Publication
(10) Pub. No.: US 2003/0124480 A1
(43) Pub. Date: Jul. 3, 2003

(54) Adjustable orthodontic band

(76) Inventor: James Clayton Peacock III, San Carlos, CA (US)

Correspondence Address: James C. Peacock III, 3317 Melendy drive, San Carlos, CA, 94070, US

(21) Appl. No.: 10/253,563

(22) Filed: Sep. 23, 2002

Related U.S. Application Data
(60) Provisional application No. 60/324,695, filed on Sep. 24, 2001.

(51) Int. Cl. A61C 3/00

(52) U.S. Cl. 433/23

(57) ABSTRACT

An adjustable orthodontic band conforms around teeth of varied sizes. The band may be elastic or a superelastic alloy, and elastically expands under force to fit different teeth. Or the band has shape memory, e.g. shape memory metal alloy, with variable circumference under applied energy such as heat. The band may be solid heat shrink or elastomeric polymer, or metal alloy. Or, interconnected struts are separated by voids that may receive cement or are covered with elastomer. Adjustability may vary along the band. A kit of adjustable bands has varied adjustable size ranges, and may include no more than about 8 or fewer bands together covering an overall range of up to 30% or more difference in circumference. One band having at least a 30% range of adjustable circumference also may be provided for each tooth type. The adjustable bands are pre-coated with cement, and are pre-packaged in a UV and moisture protective container. Estimated size is all that is required to choose the correct band for most teeth.

### CROSS-REFERENCE TO RELATED APPLICATIONS

This patent application claims priority to U.S. Provisional Patent Application Serial No. 60/324,695, filed on Sep. 24, 2001, incorporated herein by reference.

### FIELD OF THE INVENTION

The present invention is a dental device and method. More specifically, it is a dental band having an adjustable geometry to assist in fitting over a tooth. Still more specifically, it is an orthodontic band having an adjustable geometry to aid in placing the band around a tooth and for securing the band around the tooth for chronic wearing as a semi-permanent implant.

### BACKGROUND

Orthodontia is a widely practiced and well-known specialty field of dentistry that involves correcting the relative position and alignment of teeth within the mouth. Orthodontia is generally performed by mechanically adjusting the teeth using orthodontic appliances, and the vast majority of conventional orthodontic procedures involve the use of orthodontic bands. The detailed features of common orthodontic bands are widely known and will not be described in substantial detail in this disclosure; however, the following brief summary is provided for the purpose of a general overall understanding of the invention.

Orthodontic bands typically include annular or “ring-like” bodies that are worn as semi-permanent implants around teeth in order to interact with other orthodontic appliances during chronic orthodontic treatment. The terms “semi-permanent implant” are herein intended to mean a dental device implant that is (i) adapted to chronically dwell within the mouth of a patient for a time period beyond a dental office visit, generally for at least days, and often as long as weeks, months, or even years, but (ii) is generally adapted to be subsequently removed. Orthodontic bands also typically include coupler appliances secured to the annular bodies, such as for example winged brackets or elongated tubes. These couplers are adapted to engage force-applying members, such as elastic bands or archwires, respectively. These force-applying members are usually further engaged with other orthodontic appliances secured to other teeth (that may also be banded or otherwise have secured brackets or other similar appliances). Accordingly, forces may be applied between the teeth via the action of the force-applying members on the orthodontic bands as the force-bearing members on the teeth. These forces are intended to either: move each of the respectively engaged teeth with respect to each other, or move a particular one or more of the respectively engaged teeth with respect to another one or more of the engaged teeth being used as an anchor. Such movements are generally controlled toward a desired permanent result, which is accomplished through periodic mechanical adjustments by orthodontic professionals in the course of chronic orthodontia treatment.

Accordingly, it is generally important that an appropriate orthodontic band design provide sufficiently retention in the desired position in which it was secured to a tooth while chronic forces are applied to the band via the respective coupler appliance. Otherwise, movement of a band from its previously secured position would modify the forces being applied to the respectively banded tooth, and to the other coupled teeth, and also possibly damage the respectively banded tooth or other adjacent structures. It is also generally important that orthodontic bands are sufficiently well fitted with a tight tolerance around the respectively engaged teeth in order to, for example: ensure the retention just described; prevent unwanted interference between the secured bands and adjacent structures such as other teeth, the patient's lips or tongue, or other appliances; and to prevent unwanted penetration of food or bacteria between the orthodontic bands and the respectively secured teeth.

In consideration of these intended uses and respective criteria for appropriate orthodontic band designs just described, various different types of orthodontic bands have therefore been disclosed and developed.

One type of orthodontic band that is generally the most widely used in conventional orthodontic procedures is the “preformed” type. The term “preformed” as applied to orthodontic bands is herein intended to mean having a predetermined, relatively fixed geometry during the tooth fitting and securing process, though a limited degree of material deformation may occur in response to normal forces during fitting over the tooth surface. Conventional designs for preformed orthodontic bands are usually constructed of solid metal, such as stainless steel (although sometimes other metals such as silver or certain specific metal alloys have been used) and are therefore relatively rigid. While these types of bands may experience some degree of geometric change during placement, such change is generally a result of force induced, substantially plastic deformation of the band material as it is jammed down over a tooth. In fact, the stainless steel material used in most preformed bands is disclosed to exhibit a maximum strain of only 0.5%-0.8% before undergoing unrecoverable plastic deformation. Therefore, conventional pre-formed orthodontic bands are also generally considered to be substantially non-elastic.

The typical fitting and placement procedures for conventional preformed bands includes the following steps (with respect to a particular tooth to be banded): (a) initially forcing multiple bands over the tooth until one is discovered to fit snuggly with force over the tooth; (b) forcing the chosen band over the tooth with a thin layer of curable cement between the band and the tooth surface, sometimes using the aid of a patient's own forceful bite down onto a seating tool placed in contact with the band; and (c) curing the cement, usually using an energy source such as light.

This conventional, preformed orthodontic banding procedure is often very time consuming and tedious for the orthodontic professional. Also, due to the non-reversible plastic deformation during placement, multiple bands are often discarded that become damaged (or because they otherwise become contaminated) during unsuccessful initial attempts at getting just the right fitted match for a particular tooth. Moreover, the preformed band placement method is often a painful and traumatic ordeal for the patient. Still further, orthodontic offices are required to stock a significant number of preformed band sizes, which number can reach several hundred.

Therefore, various attempts have been made to improve orthodontic bands and the respective ability to appropriately fit them onto teeth having widely varied sizes and geometries.

For example, certain previous disclosures have attempted to improve the conventional “force-fitting” process for securing preformed orthodontic bands onto teeth. Multiple disclosed devices and methods provide protrusions or driving notches on the outer surfaces of preformed orthodontic bands in order to assist the seating tool in jamming the band over a tooth. One particular disclosed device further includes an antitip rest that encounters the occlusal surface of the tooth in order to better control the final position of the preformed band as it is jammed into place. Another previously disclosed device and method attempts to customize the size of a preformed orthodontic band to a particular tooth to be fitted. A magnetic field is used to crimp a previously unformed orthodontic band into a customized, preformed geometry over a replica of the tooth that is later removed. The crimped orthodontic band is therefore a preformed type that is preformed to better match a particular tooth's geometry. However, tight tolerances are still required for the tooth-band fit; concerns such as retention, occlusion, and penetration of contamination into cemented areas between the band and the tooth, together mandate a tightness during chronic wearing that does not comport with easy placement.

Various references therefore attempt to improve retention of preformed orthodontic bands by providing surface modifications to an otherwise solid, rigid annular band wall. The surface modifications are intended to provide for penetration of bonding cement to increase bond strengths of the preformed band around the tooth.

Various more detailed examples of orthodontic bands such as of the type just described are disclosed in the following U.S. Pat. Nos. references: 4,015,333 to Dellinger et al.; 4,192,068 to Wolfson; 5,338,191 to Hamula; and 5,911,575 to Devanathan. The disclosures of these references are herein incorporated in their entirety by reference thereto.

Adjustable Dental Bands

Adjustable bands have also been disclosed within various fields of dentistry. While various references use similar terms in different contexts, the following terms are herein intended to have the following meaning as used in the text of this document. The terms “adjustable bands” as herein applied to dental bands in general or orthodontic bands more specifically are herein intended to mean bands that have a controllably adjustable geometry as they are positioned around teeth. The term “geometry” in this context generally includes any spatial aspect or description of an object, such as for example shape, size, dimension, etc. The term “adjustable” is herein intended to mean an ability to change that is substantially greater than conventional preformed orthodontic bands just described above, e.g. beyond the amount of plastic deformation conventional, solid metallic preformed bands may undergo under typical clinical forces of jamming them down over a tooth. Typically, such adjustability generally comprises a mechanism beyond mere plastic deformation of material in the band wall.

Several dental bands have been disclosed for use as matrix bands for molding tooth reconstruction or repair materials. These types of matrix bands are generally constructed to dwell within a patient's mouth only during the tooth repair procedure at the dental office. Therefore, they are usually not constructed to be semi-permanent implants such as orthodontic bands. Various detailed examples of adjustable matrix bands such as of the types just described are disclosed in the following U.S. Pat. Nos. references: 1,670,361 to Johnson; 2,790,238 to Trangmar; 3,812,585 to Balson; and 3,829,975 to Balson. The disclosures of these references are herein incorporated in their entirety by reference thereto.

Many adjustable dental bands have also been disclosed for use as adjustable orthodontic bands. In fact, one reference cites a French orthodontist as having constructed the first adjustable orthodontic band as early as 1841. This same disclosure describes this early adjustable device as a precursor orthodontic band design having non-conformability problems sufficient to give way to a subsequently developed “individually-fitted” type of band (apparently involving forming a metal ribbon around a tooth and then welding it closed). The disclosure further cites the preformed type of band addressed herein above as evolving as a subsequent replacement for the individually-fitted bands.

Notwithstanding this historical account of the progression of the various orthodontic band types, this same disclosure nevertheless attempts to provide one of many other more recent attempts at an adjustable orthodontic solution to the shortcomings observed with the preformed orthodontic bands. In particular, an adjustable orthodontic band is disclosed incorporating a soft metal ribbon and mechanism for independently stretching the upper and lower halves of the ribbon to better conform to the anatomical shape of a tooth. A tang on one end of the ribbon is received within a tightening rack-and-pinion assembly that is mounted into a frame on the band and includes vertical shafts, pinions, driving heads, and locking means. This micro-machinery mechanism is a highly complex solution to the problem of adjustability and undesirably exposes various structures of the tightening assembly within the mouth. A later, related disclosure provides a modified tang on one end of the ribbon that interfaces with a more simplified shackle assembly on the other end for closing a an adjustable loop around a tooth. According to either related disclosure, the respective assemblies use circumferential tensioning to achieve conformability. However, a tooth's own contours may raise such a circumferentially tensioned band off from other contoured surfaces, and therefore may result in gap areas between the band and the tooth surface.

Other more detailed examples of orthodontic bands such as of the types just described are disclosed in the following U.S. Pat. Nos. references: 3,990,151 to Kesling; 4,840,562 to Wilson et al.; and 5,697,783 to Wilson et al. The disclosures of these references are herein incorporated in their entirety by reference thereto.

Notwithstanding the various attempts at improvements as just described, widespread industry use of the conventional preformed, solid, metallic band and related process has remained significantly unchanged. This is despite many years of significant advances and improvements in other commercial areas of orthodontic equipment.

In particular, significant research and development efforts have produced many advances in materials that have been implemented in a multitude of medical devices as well as orthodontic devices. More specifically, various pseudoelastic and shape memory metal alloys have been disclosed for use in various different medical device and orthodontic appliances. The very special properties of shape memory and pseudoelastic metal alloys have been the topic of significant study and publication, and will not be recited in significant detail here. However, for the purpose of a better understanding, the following is a brief summary of certain definitions, and includes various examples of these types of alloys and intended applications in orthodontia.

“Shape memory” alloys in particular are generally defined as a group of metallic materials that demonstrate the ability to return to some previously defined shape or size when subjected to the appropriate amount of thermal procedure. Generally, these materials can be plastically deformed at some relatively low temperature, and upon exposure to some higher temperature will return to their shape prior to the deformation. “Pseudoelastic”, often also referred to as “superelastic” alloys, are a group of metal alloys that generally demonstrate a stress-strain relationship at a particular temperature that is characterized by extreme elasticity having a relatively high strain range associated with a relatively low respective stress, and further typically characterized by very low stress-strain hysteresis. Shape memory and pseudoelastic alloys are typically described by, among other criteria, certain transformation temperatures that characterize changes between two physical states or conditions of the alloys known as “martensite” and “austenite”. Transformation between martensite and austenite states significantly influences how the alloy responds to deformation.

Specific applications of such metal alloys have been disclosed for use in orthodontia, including for example archwires, coil springs, palatal wires, and self-ligating brackets. Many different, specific compositions of superelastic or shape memory alloys have also been disclosed for use in medical and/or orthodontic device applications. The most frequently disclosed alloy includes titanium (Ti), usually alloyed with nickel (Ni), and often further alloyed with smaller amounts of other elements. For example, alloys containing substantially equiatomic amounts of Ni and Ti are often used, and may further include the addition of small amounts of other elements or stabilizers such as Cu, Fe, Co, or Cr. Nitinol is a trademarked name representing one such type of NiTi alloy that has found many commercial applications in medicine in particular.

Other specific examples of metal alloys that have been disclosed for possible use in various medical devices or orthodontia applications, including examples of shape memory or superelastic alloys, include the following:

(i) 55% Ni, 45% Ti;

(ii) equal amounts of Ni and Ti with 10 atomic % of copper;

(iii) copper/zinc/aluminium (usually 15-25 weight % zinc, 6-9 weight % aluminium, and the balance copper);

(iv) copper/zinc/aluminium/manganese; copper/aluminium/nickel (e.g. 13-14 weight % aluminium, 3-4 weight % nickel and the balance copper);

(v) copper/aluminium/nickel/manganese;

(vi) Ni—Ti—Pd alloy consisting of, by atomic percent, 34-49% nickel, 48 to 52% titanium, and 3 to 14% palladium (other disclosed variations provide for a part of the nickel and/or titanium of the alloy to be replaced with one or more of Cr, Fe, Co, V, Mn, B, Cu, Al, Nb, W and Zr amounting to 2% or less in total by atomic percent);

(vii) Ni—Ti—Cu in a composition containing (by atomic percent) 10% Cu or as much as 20% Cu, resulting in stress hysteresis of between 100-200 MPa and as low as 40 MPa, respectively;

(viii) beta phase Ti alloys, including alloys without presence of Ni, and in particular for example beta titanium alloy with molybdenum between 10-20 weight percent, aluminum between 2.8-4.0 weight percent, chromium and vanadium between 0-2.0 weight percent, and niobium between 0-4.0 weight percent;

(ix) a primary constituent at least one element selected from the group consisting of Ti, Zr, Si, Mo, Co, Nb and Be, in the range of about 30-85% by weight of the alloy, w/optional secondary alloy element of Ta, Cr, Al, V, Pd, Hf, or Fe between about 0.5-10% or about 1.0-10% by weight of the alloy (specific exemplary alloy of 45% wt Nb, with the balance Ti); and

(x) titanium based alloy having about 2-30 weight percent Mo and up to about 30 weight percent Hf, w/optional addition of Cr, Si or Fe in small amounts or increase levels of interstitial oxygen, nitrogen or carbon to increase strength, and/or optionally with Mo partially substituted by Nb to maintain low elastic modulus.

More specific examples of metal alloys, including superelastic and/or shape memory alloys, that may be used in orthodontic appliances, such as according to the general examples just described above, are variously disclosed in the following U.S. Pat. Nos. References: 4,037,324 to Andreasen; 4,197,643 to Burstone et al.; 4,818,226 to Berendt et al.; 5,044,947 to Sachdeva et al.; 5,080,584 to Karabin; 5,167,499 to Arndt et al.; 5,429,501 to Farzin-Nia et al.; Re. 35,170 to Arndt et al.; 5,685,711 to Hanson; 5,711,666 to Hanson;. 5,885,381 to Mitose et al.; 5,904,480 to Farzin-Nia et al.; 5,951,793 to Mitose et al.; 5,954,724 to Davidson; 6,200,685 B1 to Davidson; 6,258,182 B1 to Schetky et al.. Other examples are disclosed in the following published PCT Patent Application: WO 98/02109 to Finander et al. The disclosures of these references in this paragraph are herein incorporated in their entirety by reference thereto.

Interestingly, use of shape memory or superelastic metal alloys in constructing novel orthodontic appliances has heretofore been generally limited to various force applying members, such as springs, arches and wires. It is believed that the features and benefits of these advanced materials have yet to be applied to the orthodontic bands that bear the loads of these force carrying members. In particular, the deformation and recovery properties of these materials have yet to be applied to a solution that meets the problem of providing a reliable, efficient, conformable, relatively trauma-free adjustable orthodontic band.

There is a need for an adjustable orthodontic band that provides for an improved fitting process and retention versus conventional preformed orthodontic bands.

In particular, there is a need for an adjustable orthodontic band that can be placed easily onto a tooth and retained securely there as a semi-permanent implant for use in a chronic orthodontia procedure.

There is also a need to simplify and reduce the inventory of orthodontic bands within an orthodontic office.

There is also a need for an adjustable orthodontic band that overcomes the shortcomings of the prior adjustable orthodontic band attempts.

There is also a need for an adjustable orthodontic band that provides one or more band sizes that may be used over a wide range of tooth sizes and geometries.

There is also still a need for a kit of adjustable orthodontic bands that allow for accurate band sizing without requiring highly technical diagnostic tooth measurements.

There is also still a need for a kit of adjustable orthodontic bands that are pre-coated with adhesive cement and are individually pre-packaged, such as in a sterile, UV protected, and moisture protected disposable package.

There is also still a need for an adjustable orthodontic band that incorporates an appropriate shape memory and/or superelastic material in a manner that allows for the controllable adjustability of the band as it is fit around and secured to a tooth.

There is also still a need for an orthodontic band that may be heat shrunk over different teeth of widely varied sizes.

There is also still a need for an annular ring constructed of a superelastic or shape-memory metal alloy that is adjustable from a first configuration having a first diameter to a second configuration having a second diameter that is less than the first diameter that is adapted for use in securing the annular ring device around an anatomical structure in a body of a patient, in particular around a tooth for use as a dental band.

### SUMMARY OF THE INVENTION

The present invention is a system and related method that provides a band as an annular ring that is adjustable from a first configuration having a first diameter to a second configuration having a second diameter that is less than the first diameter. The band thus is adapted to be placed around an anatomical structure of a patient in the first configuration and be secured to and around the anatomical structure in the second configuration. The adjustable band is beneficially adapted for use as a dental band and related method for securing and retaining the band to a tooth, and still more beneficially adapted for use as an orthodontic band and related method. The adjustable dental band is thus adapted to be placed in the first configuration loosely surrounding a tooth and then be adjusted to the second configuration tightly fitting over that tooth so that it can be retained in place as a semi-permanent implant, such as beneficially for chronic orthodontic procedures.

This inventive adjustable band and related method thus alleviates the conventional rigors of forcing tightly fitted bands over teeth prior to cementing, and allows for a given band to fit over a wider range of tooth sizes and shapes. Thus the overall fitting and securing procedure is more efficient for the orthodontic professional, and is less painful for the patient than available with other prior bands, and the number of different band sizes that must be maintained in an orthodontic office inventory may be reduced.

Accordingly, the following modes, aspects, embodiments, and variations are intended to achieve the goals just described; while each should be considered independently beneficial, the invention is further contemplated to independently include various combinations and sub-combinations thereof as would be apparent to one of ordinary skill based upon this disclosure.

Accordingly, one aspect of the invention is a system for placing and securing an adjustable orthodontic band around a tooth. The system of this mode includes an adjustable orthodontic band that has an annular body with a wall that circumscribes a bore that extends along a longitudinal axis between a first end and a second end of the body. The body is adjustable between first and second configurations such that the bore is adjustable between first and second inner diameters, respectively. The first inner diameter is greater than an outer profile of the tooth such that the body is adapted to be placed loosely around the tooth. The second inner diameter is less than the first inner diameter and sufficiently approximates the outer profile of the tooth such that the band may be secured in the second configuration around the tooth with sufficient retention to be worn as a semi-permanent implant for use in chronic orthodontic procedures.

In one mode of this aspect, the bore extends along an axis between a top end and a bottom end of the body, and the diameter of the bore is adjustable along the entire length of the body relative to the axis.

In another mode, the body is adjustable between the first and second configurations without use of micro-mechanical machinery such as a ratchet assembly.

In another mode, the body is adjustable between the first and second configurations without compromising the profile of the band off of the tooth surface within the patient's mouth. In one beneficial embodiment of this mode, the band has a substantially uniform profile relative to the outer tooth surface in the first and second configurations.

In another mode, the body has a wall that is constructed of a material that exhibits a material response in the presence of an applied energy field, and the material response adjusts the wall between a first condition, that characterizes at least in part the first configuration of the body, and a second condition, that characterizes at least in part the second configuration of the body. The wall according to one embodiment may be adjusted from the first condition to the second condition in the presence of the applied energy; in another embodiment, the wall is adjusted from the second condition to the first condition in the presence of the applied energy.

In a further embodiment, the material is a shape memory material, and in a particularly beneficial variation the shape memory material is a shape memory alloy.

In one particular shape memory alloy variation, the wall is adapted to couple to an electrical circuit such that electrical current flowing through the wall heats a substantial portion of the shape memory alloy. The material response of the alloy to heat adjusts the wall between the first and second conditions, and in a highly beneficial variation adjusts the wall from the first condition to the second condition to thereby reduce the inner diameter of the bore around the tooth. Further to the electrical conduction variation, the wall may be specially adapted to couple to two electrical poles of an electrical coupling tool, and is adapted to conduct current through a substantial portion of the shape memory alloy. At least one portion of the wall may be electrically insulated in order to isolate the electrical current through a particularly desired path through the shape memory alloy. An electrical insulator may also be provided to prevent leakage current from the wall and into surrounding structures in the patient's mouth.

In another shape memory alloy variation, the wall is adapted to be adjusted to the first condition when the shape memory alloy is below a transition temperature that is equivalent to or less than the body temperature of the patient. The wall is adapted to be adjusted from the first condition to the second condition by heating the shape memory alloy above the transition temperature by passive heat transfer within the patient's mouth. In a further variation, the wall is adapted to couple to a cryogenic cooling source in order to cool the shape memory alloy below the transition temperature for adjusting the wall to the first condition.

In another embodiment, the material is a superelastic metal alloy. In one variation of the superelastic alloy, the superelastic metal alloy is in a superelastically deformed state in the first condition, and the wall is adjustable from the first condition to the second condition by superelastic recovery of the superelastic alloy from the superelastically deformed state toward a superelastic memory state. In the memory state condition the bore has a resting inner diameter that may be less than the second inner diameter, or may be substantially equal to the second inner diameter. In still a further variation, a tool may be provided to force the alloy of the wall from the superelastic memory state to the superelastically deformed state.

According to a highly beneficial variation of either the superelastic or shape memory alloy embodiments, the wall comprises a titanium alloy, which in a more particular variation is beneficially an alloy of nickel and titanium.

In another beneficial variation of either the superelastic or shape memory alloy embodiments, the metallic alloy wall has a plurality of wall struts constructed of the metal alloy material and that define a plurality of voids through the wall. The struts are arranged in a pattern and are adapted to change their relative positions with respect to the pattern of voids and thereby change the shape of the wall as it is adjusted between the first and second conditions.

In another embodiment, the wall is responsive to one or more of an applied light, magnetic, electrical, sonic, or thermal energy when it is adjusted between the first and second conditions. In another embodiment, the material is a heat-shrinkable polymeric material. In a further variation, the heat shrinkable may be a polymeric material, such as for example a polyimide, polytetrafluoropolymer such as polytetrafluoroethylene (PTFE) or polytetrafluoropropylene, polyethylene, or copolymer.

Another aspect of the invention is an annular band that is adapted to be positioned around and secured around an anatomic structure in a body of a patient. The band has a body with a wall that circumscribes a bore that extends along a longitudinal axis between a top end and a bottom end of the body. The body is adjustable between a first configuration wherein the bore has a first inner diameter and a second configuration wherein the bore has a second inner diameter that is less than the first inner diameter. The first inner diameter is sufficiently larger than an outer diameter of the anatomical structure such that in the first configuration the body is adapted to be placed loosely around the anatomic structure with the anatomic structure located within the bore. The second inner diameter sufficiently approximates the outer diameter of the anatomical structure, such that by adjusting the body from the first configuration to the second configuration with the anatomical structure within the bore, the body is adapted to contract around the anatomical structure and to be secured with a substantially tight fit around the anatomical structure.

According to a particularly beneficial mode of this aspect, the band is adapted to be positioned around and secured around a tooth in a patient's mouth.

According to another beneficial mode, the wall of the band is substantially continuous in both the first and second configurations.

In a further beneficial mode, the band has a coupler assembly secured thereto for engaging a force-applying member, such that the band is adapted to be worn around the tooth as a semi-permanent implant for use in chronic orthodontic procedures.

According to a further mode, the band is a shape memory alloy; in a further aspect the band is a superelastic metal alloy. In either the shape memory or superelastic alloy aspects, the wall may comprise a plurality of interconnected struts that are adapted to reconfigure their relative orientations in order to reshape and adjust the diameter of the band.

Another aspect of the invention is an orthodontic appliance system that includes an adjustable orthodontic band. The band has an annular body with a circumferential wall that circumscribes a bore aligned with a longitudinal axis and extending along a length or height of the band between top and bottom ends. The annular body is adjustable between a first configuration and a second configuration as a result of a material response of the wall to applied energy from an energy source. The bore thereby has an adjustable inner diameter between a first inner diameter in the first configuration and a second inner diameter in the second configuration. In at least one of the first and second configurations the bore is adapted to house the patient's tooth with the annular body secured and retained with a substantially tight fit around the tooth such that the band may be worn as a semi-permanent implant on the tooth for use in chronic orthodontia procedures.

Another aspect of the invention is a dental or orthodontic appliance system having an adjustable orthodontic band with an annular body. The annular body has a circumferential wall that circumscribes a bore aligned with a longitudinal axis and extending along a height between top and bottom ends of the body. The wall is constructed at least in part from a metal alloy that is characterized as having at least one of superelastic or shape memory characteristics. Accordingly, the annular body is adapted to be secured to and retained with a substantially tight fit around the tooth with the tooth located at least in part within the bore and is adapted to be worn as a semi-permanent implant on the tooth for use in chronic orthodontia procedures.

Another aspect of the invention is a dental appliance system that provides a band having an annular body with a wall that circumscribes a bore aligned with a longitudinal axis and extending along a height between top and bottom ends of the band. The wall is constructed at least in part from a material that exhibits at least one of superelastic or shape memory characteristics. The annular body is adapted to be secured to and retained with a substantially tight fit around the tooth with the tooth located at least in part within the bore and is adapted to be worn as a semi-permanent implant on the tooth for use in chronic orthodontia procedures.

According to various specific and beneficial modes of this aspect, the material may be a metal alloy, and may be further characterized as being either a shape memory metal alloy or a superelastic metal alloy. In either case, the alloy in further embodiments may include titanium or nickel or both, and in a particular beneficial mode contains nickel and titanium in equiatomic proportions.

In another beneficial mode, the annular body is adjustable without substantially experiencing plastic deformation between a first configuration having a first inner diameter and a second configuration having a second inner diameter that is substantially less than the first inner diameter. According to this mode, the band is adapted to be secured to and worn around a tooth in one of the first and second configurations, but is not suitably adapted to be secured to and worn around the tooth in the other of the first and second configurations.

Another aspect of the invention is a medical device implant that includes a tubular member with a wall circumscribing a bore aligned with a longitudinal axis and extending between first and second ends of the tubular member. The tubular member is adjustable between a first configuration and a second configuration as follows. In the first configuration the bore has a first inner diameter and the member is adapted to be delivered into the body at a first location. In the second configuration the bore has a second inner diameter that is less than the first inner diameter. The tubular member is adapted to be implanted at the location in one of the first and second configurations, whereas construction of the member to be implanted in one configuration provides substantially unique benefits to a construction that adapts the member to be secured in the other diameter of the other configuration.

According to one further mode of this aspect, the tubular member is substantially annular with a height between the first and second ends that is less than the diameter of the bore transverse to the longitudinal axis.

Another aspect of the invention is a system that provides a dental band that is adapted to be worn around a tooth of a patient. The band has an annular body with a circumferential wall that circumscribes a bore that extends along a longitudinal axis; the body is adapted to receive a tooth within the bore and the wall is adapted to be secured around the tooth. A coupler assembly is attached to the body and is adapted to engage a force bearing member within the mouth of the patient. Further to this aspect, the circumferential wall is constructed at least in part from a material that exhibits greater than about 3% elongation before experiencing plastic deformation, and may exhibit greater than even about 5% elongation before experiencing plastic deformation.

In one mode of this aspect, the material exhibits between about 5% and about 10% elongation prior to experiencing plastic deformation. In another mode, the material exhibits substantially non-plastic deformation for elongation up to at least about 5% elongation, and experiences at least one of substantial plastic deformation or yield failure for elongation of greater than about 10% elongation.

Another aspect of the invention is a system that provides a dental band with an annular body and a coupler assembly. The annular body has a circumferential wall that circumscribes a bore that extends along a longitudinal axis between first and second ends of the body. The body is adapted to receive a tooth within the bore and the wall is adapted to be secured around the tooth. The circumferential wall comprises at least one substantially solid strut that is bordered by at least one void region through the wall and through which the bore communicates externally of the body between the first and second ends. The coupler assembly is attached to the body that is adapted to engage a force bearing member within the mouth of the patient.

Still another aspect of the invention provides a method for securing an annular body as an implant around an anatomical structure of a patient. The method according to this aspect includes the following: (i) providing the annular body in a first configuration having a first inner diameter; (ii) adjusting the annular body from the first configuration to a second configuration having a second inner diameter that is substantially less than the first inner diameter; and (iii) positioning the annular body around the anatomical structure and securing the annular body around the anatomical structure in one of the first or second configurations. Adjustment of the annular body between the first and second configurations assists the positioning and securing of the annular body around the anatomical structure.

According to one further mode of this aspect, the body is adapted to be secured in a tight fit around the anatomical structure in the second configuration. According to still a further mode, the body is adapted to be secured in a tight fit around the anatomical structure in the first configuration. In still another mode, the body is adapted to be secured in one of the configurations as a semi-permanent implant that may be later removed. In one embodiment of this mode, the body is adapted to be adjusted to the other configuration in order to assist in removing it from the structure.

The invention according to another aspect provides a means for positioning the annular body around the anatomical structure, a means for securing the annular body to and around the anatomical structure, and a means for engaging the annular body to a force applying member.

Another aspect of the invention provides an orthodontic band that is adapted to be fit over multiple teeth that have at least about a 5% difference in their circumference.

In further modes of this aspect, the band is adapted to fit multiple teeth having different circumferences of at least about: 10%, 20%, 30%, and 40%.

Another aspect of the invention provides a kit of orthodontic bands, each being adapted to fit over a range of variably sized teeth, wherein the range includes at least about a 5% difference in tooth circumference.

Another aspect of the invention provides a kit of orthodontic bands, each being adapted to fit over a range of variably sized teeth having different circumferences, and wherein the range corresponding with each band overlaps with at least one of the other ranges by at least about 1% circumference.

Another aspect of the invention provides a kit of orthodontic bands for a particular type of tooth, wherein the kit includes no more than about 8 band sizes.

Further individual modes of the aspect just described include kits with no more than about: 7, 6, 5, 4, 3, 2, and 1 band sizes. In a further highly beneficial embodiment applicable to each of these modes, the limited number of band sizes provided are together adapted to fit a range of teeth circumferences that varies at least about 30%.

Another aspect of the invention provides

Another aspect of the invention provides a kit of orthodontic bands, wherein each band of the kit is pre-coated with adhesive cement.

One mode of this aspect provides each band in an individual, sealed package. In further embodiments of this mode, the package is UV protected, is moisture protective, and/or includes a moisture absorbing material. In another embodiment, the package is disposable. In another mode, the kit includes four molar bands including a lower left, lower right, upper left, and an upper right band. In one embodiment of this mode, the kit of 4 bands is packaged together in a disposable sealed package.

Another aspect of the invention is a method for choosing an orthodontic band to fit over a tooth of a patient from a kit of orthodontic bands, each band having an identified range of tooth sizes that it fits. The method includes: comparing an estimated size of the tooth to be banded against the size ranges; and choosing the orthodontic band corresponding to the range within which the tooth size falls.

Another aspect of the invention is a method for choosing a pre-coated orthodontic band to fit over a tooth of a patient, and securing the pre-coated orthodontic band onto the tooth, both without measuring a precise dimension of the tooth. One mode of this aspect provides such method without taking an automated diagnostic measurement of the tooth.

Other additional modes of the invention include the various methods of making and using the systems, assemblies, and bands summarized above and elsewhere below.

Further modes, aspects, embodiments, and variations of the invention are also contemplated as is apparent to one of ordinary skill based upon the totality of this disclosure and as described below in the detailed description of the embodiments, including without limitation further variations of the modes, embodiments, and aspects described immediately above, as well as with respect to the claims that are appended hereto.

### BRIEF DESCRIPTION OF THE DRAWINGS

FIGS. 1A-B show back and front side views, respectively, of an adjustable orthodontic band of the invention during first and second modes of use, also respectively, wherein the band is respectively placed and secured around a tooth that is also shown.

FIGS. 2A-B show back and front side views, respectively, of another adjustable orthodontic band of the invention during first and second modes of use, also respectively, for placing and securing the band around a tooth that is also shown.

FIGS. 3A-B show partially segmented side views, respectively, of another adjustable orthodontic band of the invention with the annular body shown in respective first and second configurations, that are adapted for first and second modes of use such as those shown in FIGS. 2A-B.

FIGS. 3C shows a partially segmented side view of another adjustable orthodontic band of the invention with the wall of the annular body in a first condition that characterizes a first configuration for the annular body.

FIGS. 4A-B show back and front side views, respectively, of another adjustable orthodontic band of the invention, with the wall of the annular body shown in first and second conditions, respectively, and the annular body in first and second configurations, also respectively.

FIGS. 5A-B show back and front side views, respectively, of another adjustable orthodontic band of the invention, with the wall of the annular body shown in first and second conditions, respectively, and the annular body in first and second configurations, also respectively.

FIGS. 6A-B show back and front side views, respectively, of another adjustable orthodontic band of the invention, with the wall of the annular body shown in first and second conditions, respectively, and the annular body in first and second configurations, also respectively.

FIGS. 7A-B show back and front side views, respectively, of another adjustable orthodontic band of the invention, with the wall of the annular body shown in first and second conditions, respectively, and the annular body in first and second configurations, also respectively.

FIGS. 8A-B show back and front side views, respectively, of another adjustable orthodontic band of the invention, with the wall of the annular body shown in first and second conditions, respectively, and the annular body in first and second configurations, also respectively.

FIG. 9 shows a laterally cross-sectioned top view of another adjustable orthodontic band of the invention with the annular body of the band shown in first and second configurations.

FIGS. 10A-C show laterally cross-sectioned top views of three respective adjustable orthodontic bands according to the invention having an outer coating, an inner coating, and both outer and inner coatings, respectively, secured to the wall of the annular body.

FIGS. 11A-B show a system for securing an adjustable orthodontic band of the invention around a tooth located between two adjacent teeth during two sequential modes of use, respectively, wherein an adjustable orthodontic band of the system is placed and secured around a tooth with the aid of an actuating assembly.

FIG. 12 shows one particular actuating assembly that is adapted for use with an adjustable orthodontic band according to the system shown in FIGS. 11A-B.

FIG. 13 shows another actuating assembly embodiment for use with an adjustable orthodontic band according to the invention.

FIG. 14 shows another actuating assembly embodiment for use with an adjustable orthodontic band according to the invention.

FIG. 15 shows a Table 1 of measured circumferences over a range of conventional band samples of various sizes, and also shows various calculations comparing capabilities of certain adjustable bands according to the invention against the conventional bands measured.

FIG. 16 shows a first GRAPH #1 related to certain of the information provided in Table 1.

FIG. 17 shows a second GRAPH #2 related to certain information provided in Table 1.

FIG. 18 shows a third GRAPH #3 related to certain information provided in Table 1.

FIG. 19 shows a fourth GRAPH #4 related to certain information provided in Table 1.

FIG. 20 shows a fifth GRAPH #5 related to certain information provided in Table 1.

FIG. 21 shows a sixth GRAPH #6 related to certain information provided in Table 1.

FIG. 22 shows a seventh GRAPH #7 related to certain information provided in Table 1.

FIG. 23 shows an eighth GRAPH #8 related to certain information provided in Table 1.

FIGS. 24A-C show plan views of one set of teeth in a mouth of a patient during various respective modes of fitting a correctly sized pre-formed band to a tooth in the mouth according to a “trial and error” method representative of the prior art.

FIGS. 25A-B show plan views of a similar set of teeth during respective modes of fitting a band to a tooth according to a “first try” method using an adjustable orthodontic band of the present invention.

FIG. 25C shows a schematic view comparing a single adjustable band of the invention used in a “first try” method according to FIGS. 25A-B against the range of multiple pre-formed bands used during the “trial and error” method of FIGS. 24A-C.

FIG. 26 shows a pre-coated adjustable orthodontic band embodiment of the present invention.

FIG. 27 shows one self-contained packaging embodiment of the invention of particular use for pre-coated orthodontic bands of the type shown in FIG. 26.

FIG. 28 shows another disposable package embodiment of the invention also of particular use for pre-coated orthodontic bands of the type shown in FIG. 26.

FIG. 29 shows another packaging embodiment for use in storing multiple, pre-coated, adjustable orthodontic bands of a kit.

FIG. 30 shows an angular perspective view comparing an exemplary inventory of conventional pre-formed orthodontic bands of a particular type, such as first molar bands, against alternative embodiments of a suitable replacement inventory according to the adjustable orthodontic bands of the present invention.

### DETAILED DESCRIPTION OF THE EMBODIMENTS

The embodiments shown and herein described principally illustrate an adjustable orthodontic band for use as a semi-permanent implant in chronic orthodontic procedures. Therefore, various of the Figures show certain embodiments with respect to sequential modes of use in placing and securing the band around a tooth 1. As variously shown throughout these Figures, tooth 1 includes two opposite interproximal surfaces 3, 4, an occlusal surface 5 opposite a gum line 6, and two opposite lingual and buccal surfaces 7, 8. Other Figures illustrate embodiments without specifically showing their use with respect to teeth for the purpose of simplicity, though the description clearly contemplates all embodiments for orthodontic use according to the appropriate modes elsewhere described.

In general, similar reference numerals are shared amongst the Figures where similar features of the respective embodiments are found, though such features might include a beneficially unique aspect for a particular embodiment. Various such features are common to conventional orthodontic bands, and are provided as follows with reference to all of the Figures where appropriate.

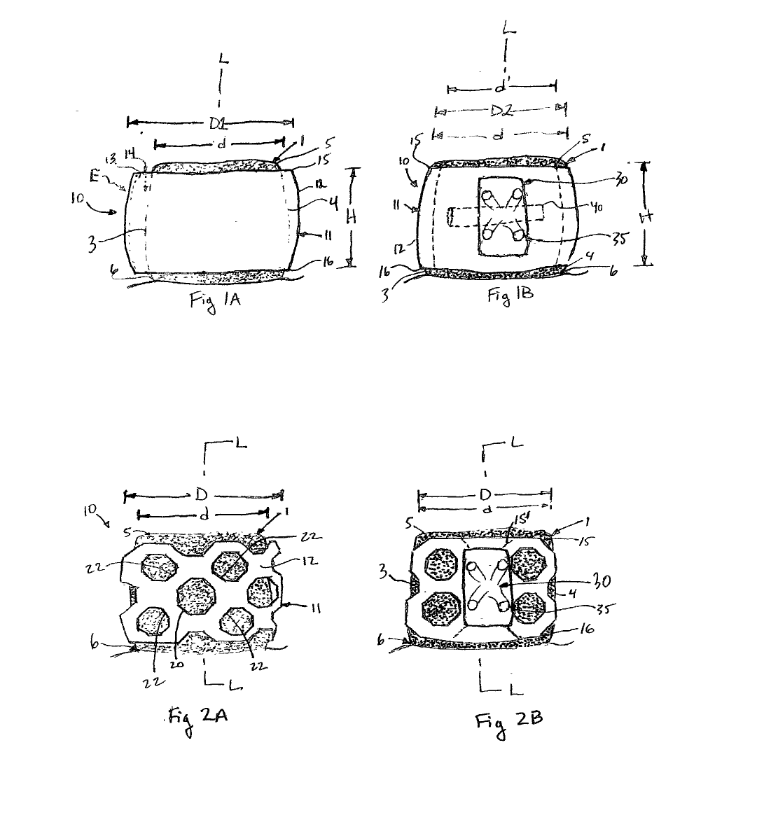

An orthodontic band 10 is provided that includes an annular body 11 with a top or occlusal end 16 opposite a bottom or gingival end 17, and two opposite lingual (tongue) and buccal (lip) sides 18, 19. Body 11 is constructed at least in part of a wall 12 having an inner surface 13 that defines and generally surrounds a bore 14 that extends along a longitudinal axis L. Wall 12 and bore 14 generally extend between occlusal and gingival ends 15, 16 over a length or height H relative to longitudinal axis L. However, it is contemplated that the occlusal and gingival ends 15, 16 for body 11 may have varied shapes or eccentricities (e.g. contours) around the band's circumference that extend along a greater or shorter height, beyond or below a completely circumferentially confined bore 14, as is well known for conventional orthodontic bands. Such is shown at contour 15′ in FIG. 2B, as will be further developed below with respect to that particular embodiment.

A bracket assembly 30 is secured on the buccal side 19 of body 11 at a base 32 located on an outer surface 15 of body 11. Bracket assembly 30 has wings or posts 35 for engaging certain force-applying members such as elastic bands or ligatures to coordinate with other orthodontic structures in the mouth in order to cooperate in moving teeth. Other structures may be provided such as grooves to receive wires, e.g. arch wires. Bracket assembly 30 may suitably substituted with other coupler appliances also adapted to engage force-applying members, such as is shown in shadow at buccal tube 40. Bracket assembly 30 may be considered as a part of an overall assembly that is orthodontic band 10; however, band 10 may also be provided as a precursor assembly without such a coupler, and such coupler may be added separately before distribution of the overall completed assembly to an orthodontic end user (or may even be added by the end user to customize the assembly for a particular patient case). For example, a base 32 may be included on body 11 for the purpose of adding a coupler such as bracket assembly 30 later, and may be adapted specifically to accommodate solder, welding, or brazing of a coupler thereto (e.g. particular materials, surface design, etc., adapted for securing the coupler thereto).

As is shown in FIGS. 1A-B and 2A-B, band 10 is adapted to be worn as a semi-permanent implant secured to tooth 1, which is accomplished as follows.

FIGS. 1A and 2A show body 11 of band 10 in a first configuration loosely positioned around tooth 1 such that tooth 1 is located within bore 14. More specifically, in the first configuration bore 14 has a first inner diameter D1 that is sufficiently greater than the outer diameter d of tooth 1 such that band 10 may be loosely positioned over tooth 1. Band 10 is adjustable in situ from the first configuration to the second configuration wherein bore 14 has a second inner diameter D2 that approximates tooth outer diameter d. As such, body 11 is tightly fit around tooth 1 and may be secured thereto, such as by aid of cement as is generally known in the art, to be worn as a semi-permanent implant.

The specific embodiment for band 10 shown in FIGS. 1A-B includes a wall 12 that is substantially uniform and solid. Such wall may comprise an elastic material, such as an elastomer, wherein the body 11 is adjusted between the first and second configurations by elastic stretching and elastic recovery of the material. Or, a superelastic alloy may also be used, though the superelastic elongation of such material may be limited in a solid annular form for wall 12 according to this embodiment and significant changes in overall circumference or diameter of the band may be difficult to achieve. It is further contemplated that a shape memory alloy may be used according to this embodiment, though again the solid annular form of the wall 12 may limit the ability for shape memory alloys to undergo substantial annular reductions without further engineering the structure of wall 12.

Nevertheless, certain metal alloys, either in shape memory or superelastic states or modes, are believed to provide a more extensive elongation than other conventional metals such as for example stainless steel or other conventional metals used for orthodontic bands. Such conventional orthodontic band metals have been reported to allow for only about less than 3% elongation prior to substantial plastic deformation, and often less than even 2% or even 1% elongation without substantial plastic deformation. For example, it is believed that certain specific shape memory or superelastic alloys may be used that provide for up to about at least 3% elongation prior to experiencing either plastic deformation or material yield such as catastrophic failure. In another beneficial aspect, such alloy may be used that experiences such % elongation between about 3% and about 10% before such plastic deformation or yield though over about 10% elongation such deformation or yield will be often experienced. Further description of acceptable materials, in particular alloys, is provided elsewhere herein.

In any event, the fully recovered condition for wall 12, either in shape memory or superelastic yield response, may comprises a different geometry than that corresponding to the tight fit over the respective tooth 1, as shown in FIG. 1B. This is illustrated by shadowed line having diameter d′ shown in FIG. 1B. More discussion about the adjusting shapes of the various band embodiments of the invention are provided elsewhere herein.

According to a further embodiment shown in FIGS. 2A-B, wall 12 is constructed of a network of interconnecting struts 22 that are separated by voids 20 through wall 12. These struts 22 have relative positions that together define the shape of wall 12. These relative positions are adapted to change as wall 12 undergoes a transition between a first shape in a first condition that characterizes the first configuration for body 11 (FIG. 2A), and a second shape in a second condition that characterizes the second configuration for body 11 (FIG. 2B). According to this network of struts 22, a wall 12 constructed of a superelastic or shape memory alloy may achieve a greater amount of annular change for bore 14, because the struts 22 cooperate to change the shape of wall 12 by bending under the forces of shape memory or superelastic recovery. This coordinated bending therefore reduces the diameter of the bore 14 defined by the wall 12 by changing the shape of the pattern of the struts 22, a more efficient mechanism for diameter reduction than by relying on simple change in elongation of the material.

The embodiments of FIGS. 1A-B and 2A-B are also beneficially adjustable over the entire height H of band 10. In other words, inner diameter D is adjustable over the entire height H. Therefore, the entire body 11, from gingival end 17 to occlusal end 16 may be placed loosely down over tooth 1 and then undergo annular reduction to fit tightly over the corresponding region of the tooth 1. Accordingly, each region of band 10 adjusts to fit over the corresponding region of tooth 1 based upon the forces of shape recovery, resulting in a highly desirable degree of conformability of the band 10 to varied teeth geometries. It is further contemplated that the band 10 may be manually repositioned over the tooth 1 during the memory recovery process in order to achieve the most desirable relative position for chronic use as a semi-permanent implant.

Further to this aspect, wall 12 may include contours along gingival end 17 and occlusal end 16 in order to achieve an appropriate amount of diameter change in those regions to accommodate more drastic tapers often found on the gingival and occlusal ends of teeth. Such edge contours may be modified to minimize unwanted roughness and maximize smoothness at the band transitions, e.g. to prevent food gathering or tongue trauma. For example, regions may be contoured where others are not; in particular the circumferential region where bracket assembly 30 is provided may not require a substantial amount of conformability but be preferably rigid, and therefore may not require such contouring (or otherwise adjustability). This region may be contoured as referenced for example at contour 15′ in FIG. 2B, or may be rigid and uncontoured.

While the specific embodiment, e.g. pattern and design for struts 22, shown in FIGS. 2A-B is believed beneficially suitable to achieve the overall objects of the invention, this specific design should not be interpreted as limiting to the broadest possible scope of the invention. For example, other shapes and patterns may be suitable substitutes, and may be particularly beneficial for a particular need.

In general, the embodiment incorporating patterned shape memory or superelastic struts 22 requires voids 20 only to the extent necessary to achieve the overall purpose of annular adjustment for band 10, and the extent that such adjustment is necessary may vary according to the specific application or tooth contemplated. Other than as necessary to achieve conformability, such voids through an orthodontic band are generally undesirable due to concerns of foreign matter or bacterial penetration and other concerns just introduced above. Therefore, specific strut/void patterns are contemplated to achieve different trade-offs between these concerns.

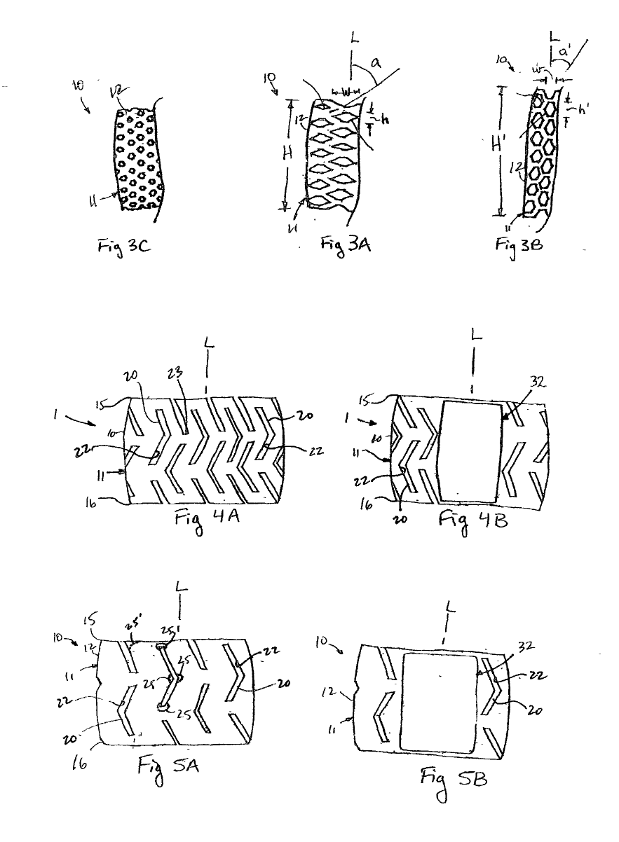

For example, FIGS. 3A-B show a denser pattern of smaller voids 20, and therefore a denser pattern of smaller struts 22. As shown in these Figures, and also in general for FIGS. 2A-B, each strut 22 is generally an elongated member that extends along an axis having an acute angle a with respect to the longitudinal axis L of body 11. As introduced above, the voids 20 provide sufficient irregularities in the wall to provide a flexibility in the struts 22 along their axis, and such axis is variable in degree and orientation, as determined in large part by the extent and pattern of such voids. According to the present embodiment, when the wall is adjusted from the first condition, or the first configuration for body 11, to the second condition, or the second configuration for body 11, struts 22 bend with respect to each other such that their relative angle a is reduced to angle a′ relative to the longitudinal axis L. According to the patterns shown in FIGS. 3A-B (and elsewhere for like embodiments, e.g. FIGS. 2A-B, and 4A-5B), the annular reduction process between the first and second configurations for band 10 effectively results in an increase in the height H of band 10. This trade-off may be acceptable for certain specific applications, and allows for certain specific strut patterns such as various of those shown and just described. Other patterns of adjustable struts may also be used without significant height adjustment during the annular adjustment process, as is elsewhere herein described. Again, the particular pattern may be varied to achieve appropriate trade-off with respect to annular inner diameter D and height H.

Further to FIGS. 3A-B, the denser pattern of voids 20 and struts 22 also provides a more localized ability to conform. With a greater number of smaller struts 22 over a similar surface area, the ability to adjust to the more localized conforms of the tooth 1 is greater. For example, FIG. 3C shows yet a further densified pattern of yet smaller and more numerous voids and struts. Also, the pattern may feel different to a patient within the mouth, and may interact differently with foreign matter. Moreover, sufficiently small voids may be easier to fill with cement during the securing process, and may result in an overall smooth feel and barrier to foreign matter penetration. However, such penetration may be more difficult to clear through general patient hygiene maintenance. Again, these trade-offs are contemplated when selecting a particular embodiment for a particular patient.

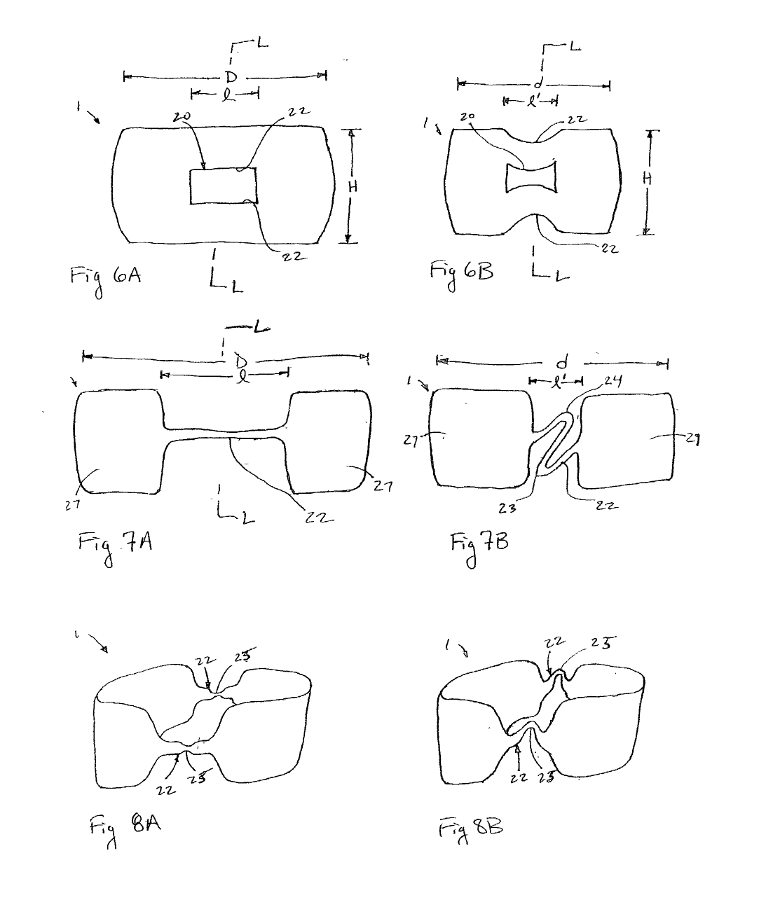

Other further beneficial patterns of struts 22 and voids 20 are shown in FIGS. 4A-5B, wherein a plurality of V-shaped grooves are provided in respectively alternative embodiments as a pattern of voids 20 through wall 12 of body 11. The V-shape of these grooves provides a defined pattern of linear interconnected struts 22 as levers or moment arms. Other patterns such as “U” or “W” shapes may be employed. As a result of the present V-shaped void pattern, a plurality of bridge struts 23 result that bridge between the interconnected V-shaped struts 22. While the bending of struts 22 substantially contributes to the overall annular reduction for body 11, bridge struts 23 may have substantially unaltered angles with respect to longitudinal axis L between the first and second configurations for body 11. Such transversely aligned bridge struts 23 may contribute to a stronger circumferential structure and therefore retention in the second configuration as the band 10 is worn and used in chronic orthodontia procedures.

In any event, a pattern of shaped grooves such as the present embodiment is believed to provide a beneficial combination of annular adjustability with minimized void surface area in wall 12. The bending moments of the resulting struts 22, however, may present certain stress regions where the voids change geometry or struts interconnect. Therefore, a further enhancement may be provided through stress relieving localized void regions 25(shown in shadow) to assist in the flexibility of the struts as then undergo bending during annular reduction.

Whereas FIGS. 4A-B show a first pattern of V-shaped voids 20 and corresponding struts 22, FIGS. 5A-B show a less dense pattern of such grooves, and therefore fewer and more substantial struts 22. Notwithstanding the benefits provided above for a greater number of smaller, more localized voids 20 and struts 22, it is contemplated that one highly beneficial band 10 according to the invention has a body 11 with a significantly greater amount of surface area devoted to wall 12, and therefore struts 22, than is taken up by voids 20. A wall surface area having less than ½ void volume is preferred, less than ⅓ still more preferable, and even less than as little as ¼ or even ⅕ even still more preferable. Such structures result in an appropriate amount of adjustability, though providing a significant strength as a force-bearing member or anchor on a tooth, as well as retention quality, in addition to prevention against foreign matter penetration into and under the band 10.

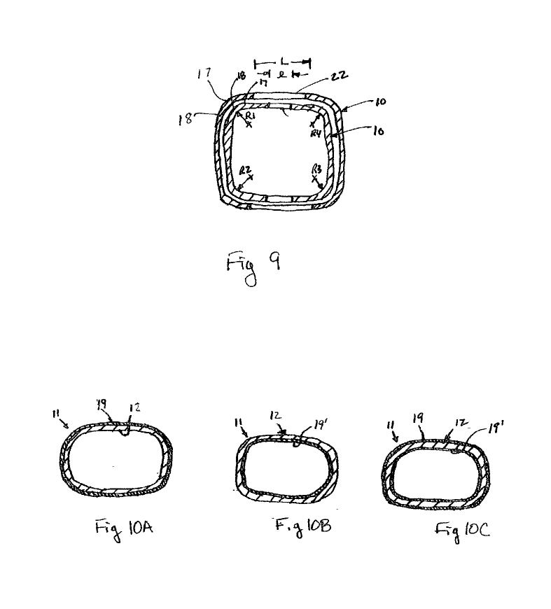

In fact, a further embodiment shown in FIGS. 6A-B illustrates that very few voids 20 and corresponding struts 22 may be suitable, and may only require as few as two struts 22 and only one such void 20. More specifically, FIGS. 6A-B show a single void 20 as a horizontally extending window between two struts 22. FIG. 6A shows band 10 in the first configuration with struts 22 extending over a length I substantially transverse to longitudinal axis L, and therefore void 20 extends over length I as well. FIG. 6B shows band 10 in the second configuration, wherein struts 22 are shown in a bent or bowed condition, essentially encroaching into void 20. As a result of this bending for struts 22, the overall length of void 20 is reduced, as is the overall circumference of body 11 and therefore the inner diameter D of bore 14. As such, other regions of the wall 12 and therefore body 11 may be further adapted to bend in order to maintain a desired shape around the circumference of band 10 as it is adjusted between the first and second configurations.

As can be appreciated, the ability to achieve the necessary annular adjustability of band 10 with only one or perhaps two voids 20 as the only windows through body 11 is highly beneficial to the extent more localized conformability is not necessary according to the more densely voided embodiments as shown above. In particular, the band 10 according to the present embodiment shown does not increase in its height H between the first and second configurations, and in fact decreases but only in the localized area of the void/struts (though it is further contemplated though not preferred that the struts may bow outward from the void rather than inward into the void). However, it is contemplated that the struts 22 may alternatively bow outward from window or void 20 in the second configuration, such as for example in order to allow a concave contour of the respectively engaged tooth 1 to be received within the area of void 20.

Such a localized void may be positioned at one place around a tooth such that the remaining aspects of the band and tooth are substantially solid and unexposed. Such position may be chosen for a particular case, but may be for example opposite a coupler assembly for engaging a force-applying member (e.g. on the lingual side of the band where the coupler is on the buccal side), or along a corner of the tooth wherein conformability is particularly desired. For example, in one particular embodiment (not shown), two opposite voids 20 may be provided as this type of localized window on two opposite interproximal surfaces 4, 5 of a tooth 1. In another embodiment (also not shown), one or more regions along the circumference of band 10 associated with a corner of the respective tooth 1 may incorporate a void such as according to the present embodiment (e.g. two corner adjacent corner regions, such as opposite a coupler assembly, may have such voided windows; or, four regions may have the voided windows to accommodate four rounded corners of a molar tooth).

Still further, the invention contemplates voids 20 broadly beyond the enclosed voids as according to the previous embodiments, and may for example comprise exaggerated versions of the contours such as provided at contour 15′ in FIG. 2B. More specifically, FIGS. 7A-B show embodiments incorporating a strut 22 extending between adjacent solid wall regions 27, which strut 22 is bordered above and below by voids 20. As shown in FIG. 7A, strut 22 according to the particular embodiment shown extends substantially horizontally (or transverse to longitudinal axis L) between wall regions 27 in the first configuration. In this first configuration, length I of strut 22 approximates the length of the void regions 20, and results in an overall diameter for band 10 equal to diameter D. However, as shown in FIG. 7B, strut 22 in the second configuration changes its shape such that the resulting length I′ of void regions 20 is substantially reduced from length I of strut 22. This reshaping of strut 22 and reduction of the length for the voids 20 results in reduction of the overall diameter of the band 10 to diameter d that is substantially less than the initial diameter D, and therefore provides the mechanism by which the band 10 is adjusted from the first configuration (FIG. 7A) to the second configuration (FIG. 7B).

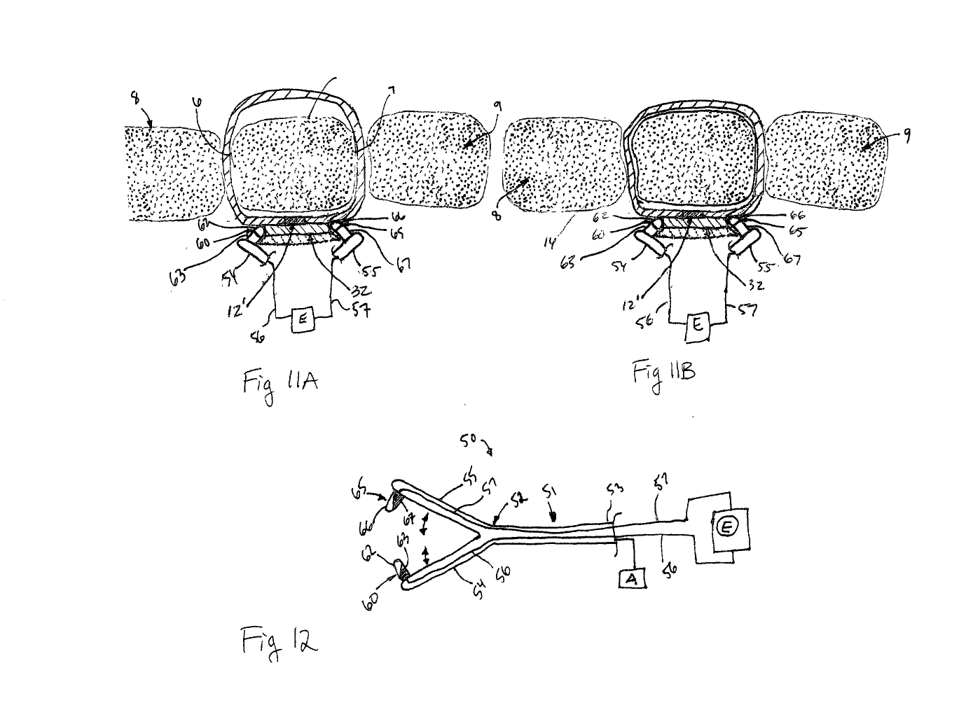

The strut and void configuration shown in FIG. 7A-B may be further modified as apparent to one of ordinary skill based upon this disclosure. For example, it is further disclosed that the transverse orientation of strut 22 in FIG. 7A and reconfigured shape in FIG. 7B may be modified into different variations and still achieve the objectives of that embodiment. In one particular further example disclosed by reference to FIGS. 8A-B, two opposite, transverse struts 22 are shown on opposite sides of a band 10 and include narrowed regions along their length, corresponding to localized void regions 25, that are adapted to provide for localized, preferential bending to result in a final desired shape for struts 22 in the second configuration, shown in one particular variation in a “U” or “V” shape in FIG. 8B.

In any event, the wall structures incorporating networked struts 22 and related voids 20 according to the various embodiments herein shown and described, may be formed according to a variety of methods. According to one example, the voids 20 may be formed within the respective wall 12 after preparing the wall 12 in a non-voided, continuous and integral tube as a blank. This may be accomplished for example by photolithography processes, laser etching such as patterned etching, electronic discharge etching or ablation, or mechanically such as drilling or otherwise cutting into the wall with another tool. Or, the wall may comprise a pattern of interconnected portions such as rings placed in series along and surrounding the vertical axis, wherein each ring forms a circumferential structure of the wall. Such rings may be attached to each other, such as via soldering, brazing, or welding. The rings may be shaped such as to have undulating bends that may be considered as struts, and the confronting bends or struts between one ring and the next may be secured to each other. Or, struts additional strut members as “bridge struts” may be engaged to adjacent rings provide the cooperating integrity of the interconnected network in the tubular band shape desired. Other conventional techniques for forming a voided tubular wall structure may also be utilized as may be apparent based upon review of this disclosure, such as for example by use of a multifilament mesh assembly (which may or may not have the filaments interconnected such as by soldering, adhering, or welding).

A principle goal of the previously described embodiments is to adjust the diameter D of a band 10 for tooth fitting. In this regard, the band diameter is contemplated to be a diameter on any particular axis transverse to the longitudinal axis L. Or, the adjustability may be along several axes, or along the entire circumference of the band 10. A decrease in diameter D has elsewhere been described according to certain embodiments to result in an increase in height H. In some circumstances, a diameter D may be adjusted along one axis at the expense of adjusting the diameter in the opposite direction along another axis. For example, when a circular ring of constant circumference is deflected or compressed along one transverse axis, it responds by an increase in diameter along another axis, such as a perpendicular axis to the compressed axis, thus ovalizing.

In one particular beneficial example using a strutted and voided wall structure of shape memory or superelastic alloy, the inner diameter of the bore may be reduced by as much as 10% or more during adjustment between the first and second configurations and without experiencing substantial plastic deformation in the wall material. Further designs are contemplated that allow as much as a 25% reduction or more, and may be even as much as up to 50% diameter reduction, all without substantial plastic deformation of the wall material that is preferably a metal alloy. Similar percent dimensional reductions are contemplated with respect to the circumference of the band, as well as cross-sectional area enclosed by the bore of the band.

Therefore, it is contemplated generally that various aspects of the geometry for the band 10 may be adjustable according to the invention, including shape, diameter, size, circumference, and height, either in combination or individually depending upon the particular circumstance. Moreover, secondary and tertiary shapes, such as curvature along the height H to accommodate the curvature of a tooth 1, may also be adjusted.

One particular beneficial example is shown in FIG. 9, wherein the overall circumference of band 10 is adjustable in a manner corresponding to an adjustable diameter over the entire circumference to “shrink fit” the band 10 around all circumferential aspects of a tooth. The specific embodiment shown has two opposite adjustable regions, shown for illustration as adjustable struts 22 such as according to the embodiments of FIGS. 6A-8B. The first configuration for band 10 is illustrated by the larger illustration having a length L shown for the strut region 22. The second configuration for band 10 is illustrated by the smaller, inner illustration in FIG. 9 wherein the length between solid regions adjacent struts 22 is reduced to length I due to reconfiguration of the strut 22. However, while the strut region 22 shortens in length, the remaining regions of body 11 may not be specifically adjustable in length along the circumference, and therefore may be required to have adjustable shape such as through bending moment.

More specifically, during the adjustment from the first to the second configuration due to the adjustment at the strut region 22, it may be desirable in some circumstances to also adjust the curvature along the other areas of the band 10 for shape conformity with localized regions of various sized teeth to be fitted. In particular, predetermined corners of the band 10 may be provided that are intended to fit onto more acute bends in a tooth and thus where tooth shape may be most variable and thus conformability the most difficult to achieve with conventional bands.

Therefore, as further shown in FIG. 9, region 17 changes its curvature between the first and second configuration, as does adjacent region 18. Whereas region 17 is the location for an acutely curved corner according to the shape of body 11 in the first configuration, in the second configuration region 17 becomes less curved and is replaced by region 18 as the more acutely curved corner for the new geometry of body 11. The invention contemplates such a relative curvature adjustment between specifically localized regions corresponding to specific, discrete geometric endpoints. Or, such relative curvature or bending adjustment may be along a continuum, wherein an overall shape for the band 10 is engineered along various different degrees of adjusting the circumference and inner diameter of the ring. For example, in the event band 10 is further adjustable to a smaller size than the two configurations shown in FIG. 9, region 18 that became the corner in the second configuration shown may be replaced by the next adjacent region as the corresponding corner for a smaller tooth to be fitted. Or, it may be sufficient to provide sufficient flexibility along regions of the band not represented by the adjustable strut regions 22 such that those regions conform to appropriate curvatures of the tooth being fitted as the struts 22 are reconfigured between first and second shapes or conditions that correspond to the first and second configurations.

In another regard, at least one surface of the band either carries or is adapted to carry a bracket which is adapted to be engaged by another orthodontic appliance when placed onto a tooth, such as an arch wire or elastic band. The portion of the band that houses the attachment of the bracket may also be desirably rigid, and may be desirably free of voids due to higher shear stress at that location during the forces of use in the overall orthodontic assembly within the mouth. It should be appreciated, though, that while each embodiment should be considered in combination with a cooperating bracket, a band blank may also be provided without a bracket and still fall within the scope of the invention, and may for example be later modified to incorporate a bracket.

It is apparent, therefore, that the present invention generally provides adjustability for a band 10 between many different sizes and shapes, though with respect to fitting a particular tooth 1 this disclosure generally describes the mechanism according to two, first and second configurations for the purpose of simplicity of illustration. Still further, it is contemplated that kits of bands 10 may be provided with various different geometric aspects indicated that may be chosen for fitting a particular tooth. Adjustable dimensions may be provided for particular: shapes, diameters along particular axes of the band body, circumferences, etc., and may be indicated for appropriate choosing to fit a particular tooth. These geometric or dimensional aspects may be indicated in each of the configurations, allowing for an informed choice for the first configuration for loose fitting prior to adjusting and securing, as well as for the second configuration for proper final fitting of these bands to teeth.

The general stiffness of band 10 is an important aspect of retention during the rigors of wearing in the mouth of a patient as an implant. This stiffness according to various embodiments herein described may also be variable along the changing geometric continuum between the first and second configurations (e.g. orientation of struts may change between sizes and may result in variable stiffness along certain axes). Also, multiple bands 10 may be provided that have size ranges that overlap. Two or more bands may be adjustable to similar sizes, but at different degrees along their ranges (e.g. different degrees of superelastic or shape memory recovery). Therefore, stiffness of a band 10 at different adjustable sizes may also be indicated so that the appropriate band may be used.

Accordingly, geometric dimensions and corresponding stiffnesses in multiple configurations may be indicated, such as by a numeric code imprinted upon each band in a kit. Or, a code may be provided on each band of a kit for the purpose of referring to a reference diagram or chart. For example, tables or curves representing this type of information may be provided for use with a kit of bands according to the invention.

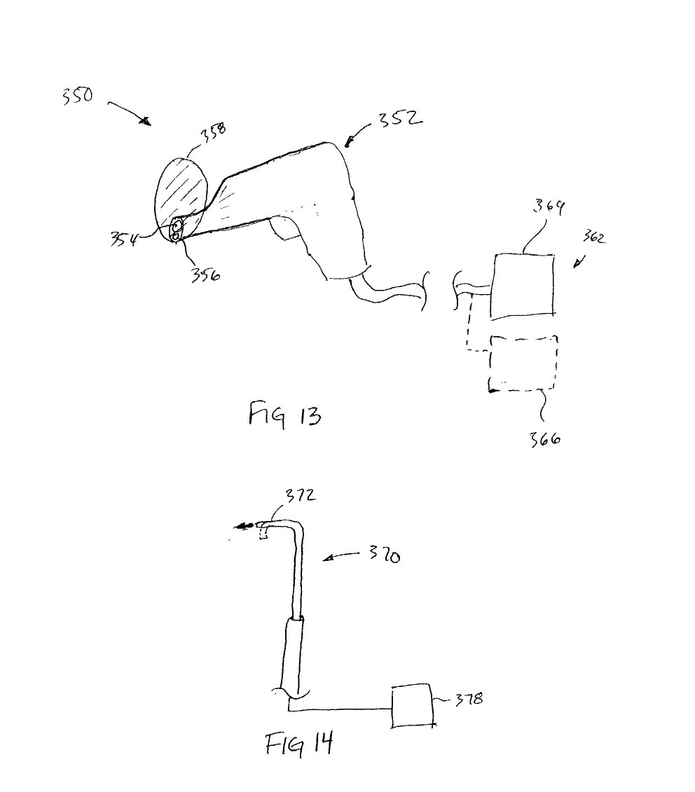

Various of the embodiments have also been described with respect to an annular band 10 having a body 11 constructed from a wall 12 having various beneficial features that provide for adjustable geometry. However, it is also further contemplated that body 11 may have other constituent parts cooperating with wall 12. In particular, an additional wall or coating may be provided, as shown in three alternative embodiments in FIGS. 10A-C.

More specifically, FIG. 10A shows body 11 to include wall 12, and also shows an outer coating 19 applied over wall 12. This is believed to be desirable in order to block voids 20 while allowing for such voids 20 to be exposed to the inner bore 14 of a band 10, which allows for cement penetration into voids 20 for good adhesion and therefore retention.

FIG. 10B shows wall 12 with an inner coating 19′. An inner coating 19′ of this type may provide better adhesion to the cement used for securing band 10 to a tooth 1. FIG. 10C shows wall 12 coated on both its outer and inner surfaces with an outer coating 19 and inner coating 19′, respectively.

These coating embodiments may be desirable for example to fill or cover void regions through wall 12, such as in order to prevent foreign matter penetration through band 10 that would otherwise promote tooth decay, or in order to provide a more smooth surface with respect to the struts 22 and voids 20 according to certain of the embodiments. Therefore, the coatings 19, 19′ may create an overall solid body 11, though wall 12 may be voided. In this case, it may be particularly desirable that the coating be flexible in order to withstand and not hinder the adjustable geometry of wall 12 and therefore body 11. For example, low modulus polymers such as polyurethane, pelathane, or hytrel may be used. Or, in another non-limiting example a rubber, such as latex or silastic rubber, including those rubbers used commonly in “elastics” already implemented in various orthodontic applications, may be used. The elastic coating may be in an elastically elongated state in the first condition, and recover toward a memory state as the band 10 is adjusted to the second condition having a smaller size. Or, the elastic coating may be in a resting or memory state in the first configuration and be compressible to accommodate the adjusting wall 12 as the size of the band 10 is reduced in the second configuration. As described above, voids 20 according to certain of the wall 12 embodiments may change shape between the configurations, and coating filling those voids may experience elastic expansion along one axis (e.g. longitudinal axis L) and compression along another axis (e.g. transverse diameter).

The coatings 19, 19′ may be secured to a wall 12 according to various generally known techniques. For example, outer coating 19 may take the form of an outer tubular wall that is secured to the outer surface 15 of wall 12, such as for example by heat shrinking the outer tubular wall down over wall 12. In such an operation, wall 12 may be supported such as for example over a stiff mandrel, which may be a stainless steel mandrel coated for example with a polymer such as a fluoropolymer, or for specifically TFE or PTFE (polytetrafluoroethylene). Or, wall 12 may be expanded into the inner surface of such an outer wall and embedded therein. The reverse may be done to form inner coating 19′, e.g. expand an inner tubular wall outward into the inner surface 13 of wall 12, or collapse wall 12 down onto an inner tubular wall. Also, coatings 19, 19′ may be formed on the respective surfaces of wall 12 by other methods, such as plasma deposition, ion deposition, sputter deposition, dip coating, solvent bonding, adhesive bonding, etc. Further to various of these methods, either the outer surface 15 or inner surface 13 of wall 12 may be masked if it is desired to isolate the process to provide only one of outer or inner coatings 19, 19′.

In any event, such a coating is desirably thin to minimize the overall profile of the body 11 as is generally desired for dental bands such as the type of this invention. Also, the coatings 19, 19′ may be clear, or may be colored, in either case impacting the visual appearance of the overall band 10 that may be chosen for a desired cosmetic effect in a particular case.

The material used for constructing wall 12 according to various of the embodiments herein shown and described may be similar to that previously disclosed for other orthodontic bands, such as a metal, for example stainless steel. In a particularly beneficial embodiment, however, the wall material is an elastic or superelastic material, or a shape-memory material.

With regard to an elastic material, the material may be an elastic polymer for example. Specific more detailed examples of elastic polymers include low modulus polyethylene, low modulus polyurethane, pelethane, and hytrel. Or, rubber may be used, such as silastic rubber or latex rubber.

With respect to superelastic material, the material may be for example an alloy of nickel and titanium, such as for example and without limitation a substantially equiatomic alloy of these metals. Or, the superelastic material may be other superelastic metal alloys known and used for other applications, including in a further non-limiting example other titanium alloys not containing nickel (which may be particularly desirable for avoiding possible nickel allergies). Many different such alloys are herein described, such as in the “Background” section above, and may be appropriately used as the wall material according to certain embodiments of the present invention. In any event, the particular ration of alloy components, and/or the processing methodology of a particular alloy, may be manipulated to provide a desired result, such as the transition temperature between martensite and austentite states, or a desired stiffness or percent elongation. Such specific ratios or processing may be customized for a particular desired result with respect to the stated goals and mechanisms of desired use of the invention according to this disclosure.

In either the elastic or superelastic case, the shape of the band in its memory state may have a diameter in the smallest condition for its intended use over a tooth, and may elastically expand its shape and diameter as it is forced down over larger teeth due to normal forces. Or, a tool may be used to expand open the band in an elastically deformed condition as it is positioned loosely around a bigger tooth, after which the band may be released from the deformed state to elastically respond and conform down over the contours of the tooth.

For the purpose of further illustration, one particular tool (not shown) is contemplated for this purpose with two opposable arms housing two opposing pairs of spaced prongs or posts may be used. The pairs of arms are placed within the bore 14 of a band 10, such as at positions corresponding to preshaped corners (e.g. corners represented by R1-4 in FIG. 9. By forcing the arms apart, the two opposing pairs of posts operate to force the body 11 into an elastically deformed condition representing the second configuration for band 10. The band 10 is then released from the tool (e.g. pushed from the tool) as it elastically or superelastically recovers around the tooth. Cement of course may be applied before or after the band 10 is positioned loosely around the tooth for fitting.

With respect to a shape-memory material, NiTi or other shape memory metal alloy may also be suitable when formed and treated to perform within its shape-memory mode. Or, a shape-memory polymer such as polyimide, polytetrafluoropolymer such as polytetrafluoroethylene (PTFE), irradiated polyethylene or copolymer may be used. In any event, shape memory properties allow the band to be adjusted between its first and second shapes for positioning and then retention onto the tooth by application of an applied energy. For example, the material may be rendered especially conformable at a first temperature as it is slid over a tooth, and then by thermal transition to a second temperature the material changes its property to a stiffer modulus that allows for a tightened, retainable fit onto the tooth. In another mode, the first shape of the material, e.g. orientation of interconnected struts 22, at the first temperature may be loose over the desired tooth, and then by transition to the second temperature the material recovers to its memory state in the second shape having a force bias to the narrower diameter thus clamping onto the tooth.

While various of the embodiments for wall 12 are herein described to incorporate voids, some specific applications of the embodiments may not require use of such voids in the wall structure. For example, heat shrink polymer materials may be suitable for use in shape-memory applications without the need for voids in the wall, since the material itself may maintain a tubular shape during adjustment between diameters. FIGS. 1A-B show an example of such design. Voids however are generally intended, though without limitation, to allow for shape adjustability of a band wall structure using materials such as shape memory or superelastic metal alloys (e.g. NiTi), as elsewhere herein described in more detail, or generally where certain dimensions or stiffness are maintained during the adjustment.

FIGS. 11A-B show an example of a system according to the invention that uses a band 10 having a body 11 with a wall 12 that is adjustable upon application of energy from an energy source E. These FIGS. 11A-B also show use of the system 1 in placing and securing a band 10 around a tooth with respect to surrounding adjacent teeth 8, 9, and in that regard is to be considered exemplary of use of various other embodiments elsewhere herein described.

Further to the particular embodiment shown in FIGS. 11A-B for band 10, wall 12 is constructed substantially of an electrically conductive shape memory alloy material, such as according to wall structures elsewhere herein shown and described. However, a locally insulated region 12′ corresponding to a base 32 for a coupler assembly is constructed of a relatively non-conductive material in an overall design that achieves the following goal. Band 10 is adapted to electrically couple to two leads 54, 55 on one side of the band 10, such as the side corresponding to a coupler assembly 30, such that insulated region 12′ is between the leads 54, 55. Leads 54, 55 are adapted to be electrically coupled via conductors 56, 57, respectively, to an energy source E that is an electrical current source. By activating energy source to apply a voltage between the leads 54, 55, insulated region 12′ allows isolation of electrical current to flow through a substantial portion of wall 12 in an electrical circuit. Wall 12 is further adapted to heat in response to such current, which heat activates a reshaping of wall 12 and therefore body 11, which corresponds to band 10 being adjusted between the first and second configurations as shown in FIGS. 11A and 11B, respectively.

Electrical current source E is preferably an alternating current source, which may in one particular embodiment be operated at a radio frequency. In the event of any leakage current into patient tissues, certain levels of current flowing at these frequencies in other in vivo applications have often been observed and reported to be better tolerated by patients as compared to lower frequency alternating currents or direct currents, which above low thresholds may be sensed or even physiologically harmful. Also, due to the relatively high electrical conductivity of most metals, even the higher impedance metals of superelastic or shape-memory alloys, it may not be necessary to insulate the wall 12 from leakage current into mouth electrolytes or patient tissues—the metal wall may be of such higher conductivity to. However, it is contemplated that electrical insulation may be provided to isolate current flow within the wall 12 and not through tissues. This may be accomplished for example via either or both of outer and inner coatings 19, 19′ previously described. Where electrical insulating is the principal goal of such a coating, it may not be necessary to specifically fill any void regions in the wall, so long as metal surfaces are protected from electrolytic tissues or fluids in the mouth. Also, where electrical insulation is provided, other frequencies than radio frequency, or direct current, may be used because current is appropriately isolated within wall 12.

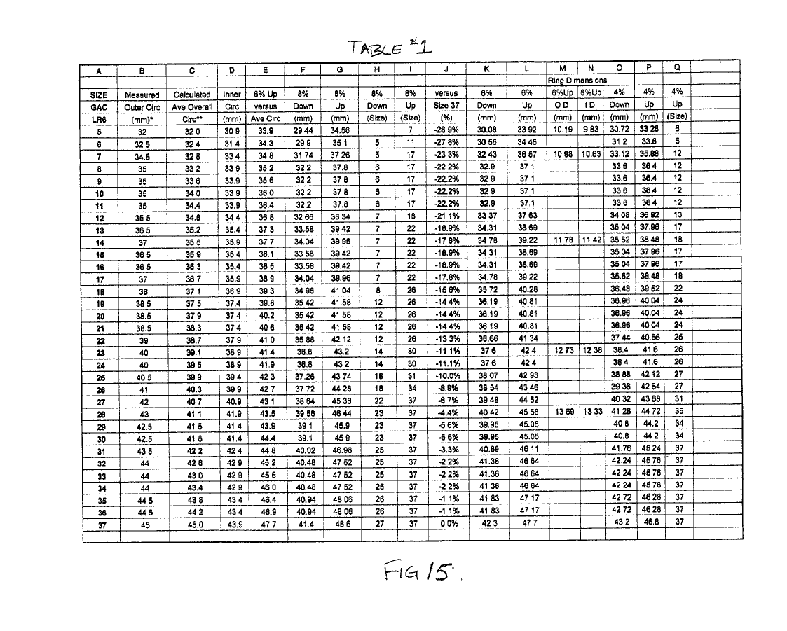

Further illustration for leads 54, 55 is provided as follows and by additional reference to FIG. 12. According to the specific embodiment shown, leads 54, 55 are provided on a distal end 52 of a body 51 of a tool 50, and are shown as two opposable, hinged arms that include posts 60, 65, respectively. These posts 60, 65 include insulated regions 63, 67, respectively, and exposed electrically conductive regions 62, 66, also respectively. Posts 60, 65 are adapted to be coupled to band 10 in a manner such that conductive regions 62, 66 confront exposed regions of wall 12 for electrical conduction between regions 62, 66 via wall 12 around insulated region 12′, and while protecting against dangerous leakage current into surrounding fluids or tissues with insulated regions 63, 67. Leads 54, 55 may be opposable according to various hinging or other mechanisms, such as known with respect to other medical or orthodontic tools, and may be accomplished through a proximal actuator A, shown schematically in FIG. 12 and that may be for example opposable proximal grips for manual manipulation to be mechanically transferred to the arm leads 54, 55 on distal end 52 of tool 50. Conductors 56, 57 extend proximally through body 51 to respective electrical couplers (not shown) for coupling to energy source E, shown schematically in FIG. 12.

According use of the embodiments herein described as semi-permanent orthodontic implants, a bonding enhancer is used to allow the band to be retained in predictable, fixed orientation with the tooth for the purpose of fine adjustment during orthodontic treatment. Therefore, conventional bonding chemicals such as photoactive cements may be employed between the inner surface of the band and the tooth. Moreover, where void embodiments are used, such cement may fill voids if provided in the band wall, which may have a smoothing effect at the outer surface 15 of the band 10 relative to the tooth 1.

Therefore, while clearly other means may be employed as sufficient substitutes for “actuating” band adjustment other than that specifically shown and described for FIGS. 11A-12, one particularly beneficial alternative “heat shrinking” means according to the invention is shown in FIG. 13 combines heat for shrink-adjusting bands with light for curing adhesive cement. More specifically, system 350 includes an actuator gun 352 that is coupled to a drive system 362. Gun 352 includes a UV light emitter with an emission tip 354 that is used by pointing the light emitting therefrom at a cemented band on a tooth in order to UV cure that cement. This is a common type of tool in this regard, and of course other types of light for other types of cement, or other energy sources may be used as apparent to one of ordinary skill.

However, as modified for the present invention, gun 352 also includes a hot air nozzle 356 that may be used contemporaneous or before actuating the UV cure, and also pointed at the band over the tooth is used to heat the band to an elevated temperature to activate the shrinkage. This is useful for example where bands used are NiTi or other heat shrinkable alloy or material. Typically, this would be done at a temperature sufficient to heat shrink the band without damaging the mouth tissues, and may be controlled such as by use of a thermocouple or thermistor at the tip and a feedback control mechanism (not shown). In any event, the gun 352 may be fully integrated with a heat source and light source, or may be coupled to the drive system 362. Drive system 362 may provide a single box adapted to provide both light and hot air to gun 352, or the components may be separate such as light box 364 and hot air box 366 shown in FIG. 13.

To further illustrate the broad scope of alternative means that may be used, FIG. 14 shows a dedicated hot air nozzle 370 that has a shaped tip 372 for pointing hot air ejected therefrom (bolded arrow) toward a band placed around a tooth (not shown), and that may have a handle 374 and is coupled to a hot air supply 378.

The various alternative heat shrinking means just described are illustrative of the various different pieces of equipment and tools may also be used in conjunction with the bands herein described. While such components may be combined together to form an overall useful system, reference to such a “system” may include only one such component to the extent it is adapted to cooperate with other components. Such other system components may include for example a tool for adjusting the size of the bands for use, such as the exemplary embodiments herein shown and described. In other examples for illustration, another type of additional tool in the system may include a band “expander” for in-lab expansion prior to fitting over a tooth. However, for many applications, the bands will be provided “pre-expanded” so they may be used directly from the package.

This description has principally focused upon the benefit of the present invention in the ability to use a single band for multiple sizes of teeth, thus limiting and possibly removing the need for choosing a specific band of specific size from a kit of variously sized bands for the purpose of bonding to a specific tooth. However, it is further contemplated that the adjustable orthodontic band of the invention may be useful for more conventional use by providing a kit of such bands of varying sizes. The ability for the bands described to conform to a specific tooth remains beneficial even in the event a similar number of bands are provided in an inventory kit and each band corresponds generally to a similar range of tooth sizes as conventional bands provide..

The sizes and shapes of the present orthodontic bands (e.g. diameter, interior cross-sectional area, etc.) are generally adapted to accommodate known size and shape ranges for teeth. As mentioned, more than one band may be provided in a kit for the purpose of accommodating different size teeth, or ranges of teeth sizes. It is generally contemplated that one band according to the invention may be used with a range of tooth sizes that is at least 50% greater than the range of tooth sizes using conventional, non-adjustable orthodontic bands, and may be as much as 100% or even 200% greater than conventional tooth size range for a conventional band. These ranges correspond to fewer bands being necessary than in conventional kits, and may require only ⅔ the number of bands of varied sizes, or even only about ½ the number of bands, and perhaps even only ¼ the number of bands in a kit to fit most patient teeth. Further examples of kits of adjustable bands according to the invention are described in detail below by reference to FIGS. 15-30.

The adjustable shape of the embodiments according to the orthodontic band invention may be achieved by reducing the overall circumference of the band, such as in order to easily place the band over the tooth and then clamping down onto the tooth as the band shape is adjusted, or in order to truly use one inventoried band size for teeth of truly varying overall size. Or, the adjustment between multiple shapes according to these embodiments may not require an overall reduction in the circumference of the band—improved conformability of such a band to the geometric shape to specific teeth is still desirable and may be achieved with the same band amongst teeth of varying shapes but having the same overall size (circumference).

In addition, the overall wall thickness of the band of the invention (from inner surface to outer surface), may be generally similar to that of conventional bands, though may vary according to material used or range of adjustability desired (thicker walls may allow for more drastic shape and size changes). Or, the wall thickness may be varied over the overall wall structure if desired (e.g. different stiffnesses and therefore different conformability at different locations along the wall). However, as mentioned above to be beneficial, the present invention does not require increased profile away from the tooth surface due to any specific structure such as corrugations, folds, or mechanical assemblies (e.g. ratchet-and-pawl) since those structures are not required to achieve adjustable size or shape according to the present invention.

Various methods of manufacturing and use have been herein described, introduced, or suggested, and are to be contemplated within the scope of the overall invention. In addition, the band embodiments may also be adjusted from a resting or stored shape to another shape for application to a tooth by use of a tooth blank. The band may be conformed to the blank, and then removed for use in orthodontic treatment. Moreover, the bands of the invention may be provided in a sterilized condition for orthodontic implantation, or a sterilization assembly may be provided for sterilization such as chemical or heat sterilization in the orthodontic office contemporaneously with implantation.

After implantation and use, removal of the bands is generally required eventually when treatment with the bands has been completed. This may be accomplished using conventional techniques. Or, certain of the adjustment mechanisms described may be reversed. For example, adjusting the temperature of certain NiTi or other superelastic or shape memory metal alloy materials to a particular temperature, e.g. back to the temperature corresponding to the first configuration, may actuate or otherwise allow the alloy to be adjusted from the condition corresponding to the implanted shape around the tooth to the another condition corresponding with another shape (e.g. the first configuration and first shape prior to securing) that is loosened from the tooth, thus accommodating removal. This may be done for example by heating or freezing the NiTi wall material of the band. Materials that exhibit shape memory only upon heating are referred to as having a one-way shape memory. Materials that undergo a change in shape both upon heating and upon re-cooling are referred to as having a two-way shape memory. Either one-way or two-way shape memory alloys may be used in the wall of the various band embodiments herein shown and described according to the present invention.

Notwithstanding the many different modes of providing band adjustability herein disclosed, or otherwise not disclosed but appropriate substitutes contemplated herein, one specific type of band that is believed to be highly beneficial for orthodontic bands is described as follows.

A molar band is formed by attaching opposite ends of a strip of material as follows. A strip of nickel titanium material is cut to a desired length and is cut to have a width providing an appropriately shaped height as an indicated band when later formed into a ring. More specifically, portions of the strip later to become proximal and medial aspects of the final ring formed may be given shorter widths than portions of the strip to correspond with buccal and lingual aspects of the band-this provides ultimate vertical heights that have been observed to provide best fit and wear characteristics on molar teeth. The material may be heat treated in the strip stage to give it desired Af or other properties, or such may be done after forming the tube. In particular, where a pattern of voids and struts is desired, such are cut into the strip before forming the tube, such as by using laser, electron discharge machining (EDM), or photo etching, machining, or chemical etching. Where polymer or other material coating is desired, such as to close the voids formed, this may be done at the strip stage, or as elsewhere herein described at the final ring stage.

The opposite ends of the strip are brought together and secured relative to each other to form a ring. This may be done by welding, soldering, adhesive, or the like. Or, they may not actually contact, but instead each be secured to an opposite side of an attachment base, such as a base of a buccal attachment, and secured there by such suitable means as just described or otherwise known. In order to ensure a robust, strong result in the ring form, the opposite ends of the strip may be left solid where other portions of the strip are voided. Or, other portions of the strip may be left relatively solid, which may be for example where buccal or lingual attachments are ultimately to be affixed.

In an alternative manufacturing mode, such strips may be made in bulk from a sheet of such material, such as a nickel-titanium sheet. After forming all or a portion of the aspects desired to be imparted to such strips prior to forming rings therefrom, they may be cut from the sheet. In another mode, multiple such strips may be formed from a continuous reel or relatively long discrete strip fed through or otherwise exposed to such cutting and forming processes as described.

In still another alternative mode of manufacturing the rings forming orthodontic bands herein, a block of suitable material may be provided as a work piece, and rings may be cut therefrom, such as using EDM.

### EXAMPLES

Further to the foregoing embodiments, certain experiments have been conducted to confirm and specify more specific features that are believed to provide commercially viable product designs for specific molar band applications as follows.

One exemplary inventory of lower right molar bands (“LR6”) from a leading supplier, GAC, was evaluated to determine their dimensions, and then various calculations were made and appropriate conclusions were drawn regarding various appropriate modes for replacing such inventory with an inventory of improved molar bands according to the present invention as follows.

Thirty-two different band sizes, or one band each of sizes 5 through 37 (incrementally designated in steps of one whole unit, 5 being smallest, 37 being largest in circumference/diameter), were measured for overall circumference as follows. A loop of string was wrapped around an outer surface of the band at a location adjacent to the base of the buccal attachment and on the opposite side adjacent the lingual attachment. Then the string was marked with ink pen where opposite ends of the loop overlapped. The marked loop was thereafter removed from the outer circumference of the band, and then cut to length between the markings and such length was subsequently measured and recorded.

FIG. 15 shows a Table #1 that includes the general results of the outer circumference measurements in Column B for each of sizes 5-37 listed in Column A. An additional Column C is provided to give a more standardized form of outer circumference measurements, with calculated outer circumferences based upon the difference over the entire range between the smallest band size 5 and largest band size 37, divided by the number of sizes, or 32. This was done in order to provide a smooth average estimated size difference curve, since the measurements for each size were done over only an n=1. A further calculation for the circumference at the inner surface of these bands is shown in Column D, based upon estimated wall thickness of 0.007 inches

In addition, the following additional columns in FIG. 15 (Table #1) are explained as follows. Columns F to G, respectively, show calculated dimensions representing an 8% change down and up, also respectively, from the measured circumference for each band size—this provides an estimate for the maximum range of nickel-titanium alloys known to be about 8% elastic yield. Columns H to I show the band sizes that represent the limit to which a band will fit after experiencing 8% band size adjustments represented by the calculations in Columns F to G, respectively. Column J shows percent reduction from a band size 37 necessary to fit each other smaller band size in the table. Columns K to L are similar calculations provided in Columns F and G, respectively, except addressing a range of adjustability of only 6%—this is done to estimate sizing ranges in the event full material limits are not reached, such as due to material constraints or design constraints, and in any event allows for more tolerance at the ends of the ranges in the event better than 6% adjustability is attained in a particular embodiment of adjustable band. Columns M to N provide some exemplary outer diameter (“O.D.”) and inner diameter (“I.D.”) dimensions for 5 cut ring sizes that may correspond to 5 band sizes capable of replacing the sizes 5 through 37 of conventional bands based upon 6% size adjustability. Columns O-Q represent various calculations similar to others provided and as indicated at the tops of the columns based upon a 4% overall circumference change from each starting size—this may be representative of adjustability of an overall solid NiTi band having a portion of its circumference of fixed length due to inclusion of a non-adjustable attachment (e.g. buccal tube or wing fixtures), and where the material is not demonstrating all of the generally accepted maximum yield for non-plastic deformation for the material of about 8%.

As an interesting result of the measurements made, it appears that each size of conventional band differs from the next by only slightly more than 1%, with an overall range of about 40% change from the smallest band size 5 to the largest measured size 37. The measurements and calculations provided by Table #1 in FIG. 15, though estimates, provide some valuable insight into a wide variety of different kits or product lines that become possible according to the present invention, as illustrated by reference to various graphs in the Figures as follows. In particular, various such kits are portrayed in the graphs based upon overlaying different percent size changes capable under the present invention versus the incremental size differences using the conventional stainless steel bands measured.

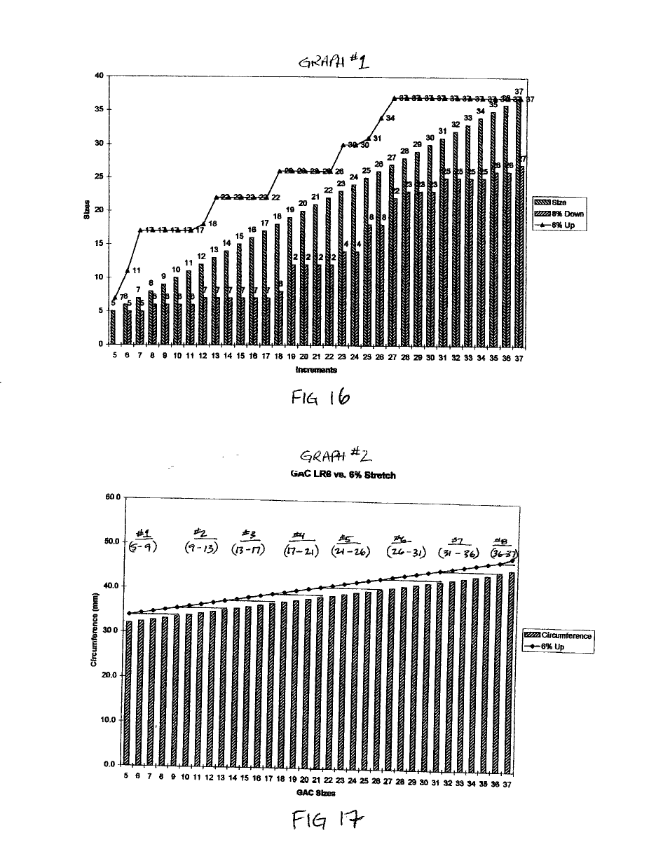

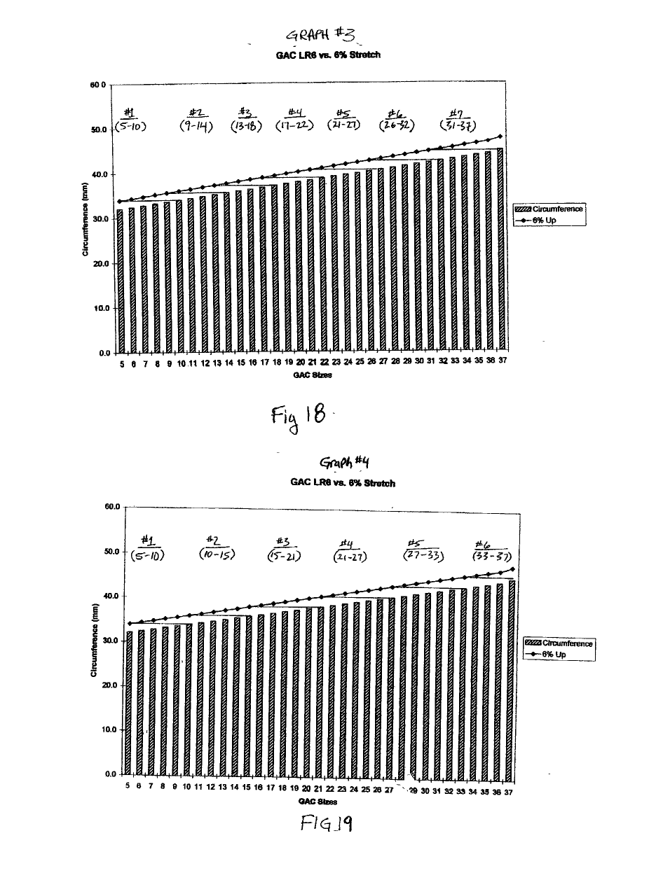

For example, FIG. 16 shows Graph #1 wherein each conventional size measured is displayed by reference to the other conventional band sizes that may be captured with 8% expansion or contraction from a band starting at each size designated (e.g. “8% Up” or “8% Down” curves shown). This provides insight into the types of ranges of bands that can be replaced by bands of the present invention having up to 8% size adjustability.

FIG. 17 shows a Graph #2 that displays certain sizing ranges representing one particular kit of bands according to the invention based upon 6% change. More specifically, horizontal lines from various points in the “6% Up” graph show the range of sizes that may be captured by 6% band expansion from the initial size from which the line is drawn. In this particular embodiment, a further criteria is that the largest size captured must have a circumference that fits beneath the 6% size range—furthermore, this sizing process was started at the smallest band size, and allowed for each size range identified to have one band size of overlap. This overlap allows for less error in proper band sizing if a tooth fits between the ranges (e.g. either of two bands fitting adjacent ranges will work for a tooth falling exactly at the limits between such ranges). In any event, the resulting kit of bands meeting these criteria are summarized by notes above the graph curves, providing 8 different sized bands, each one variously providing adjustability to replace 4, 5, or 6 bands, and at the very top of the range the largest band #8 fits only two sizes per this kit and the parameters related thereto. However, many practices may not wish to even inventory such large bands, and therefore a kit may be provided that has variously sized, adjustable bands, each replacing at least 4 of the conventional bands.

As an additional note, it is believed that, for the particular conventional bands sampled available from GAG, a majority of patients are sized between 17 and 21. Accordingly, most patients may be fitted with one of these sizes, size #4 shown. Moreover, for this and other kits that may be provided according to the adjustable bands of the invention, an inventory may be provided that contemplates such usage, such that more units are provided for specified sizes, and less for other sizes at the extremes. For example, for the kit portrayed by the Graph #2, there may be far more bands of Size #4 than other sizes, fewer for sizes #3 and #5, still fewer of sizes #2 and #7, and the least for sizes #1 and #8.

Another example is shown in Graph #3 in FIG. 18 and shows the same starting curves for the average measured band circumferences and 6% expansion range, respectively, but overlays ranges of adjustability per the present invention with a slightly modified set of criteria in comparison with the prior Graph #2 in FIG. 17. More specifically, here band ranges were allowed to extend to the maximum possible larger size along the X-axis, not providing for the tolerance at the upper end of the range as provided in Graph #2 sample. In addition, however, an overlap between ranges of two band sizes is required per this criteria. As shown, the bands required per this overall change of criteria based upon the same starting data drops from 8 to 7.

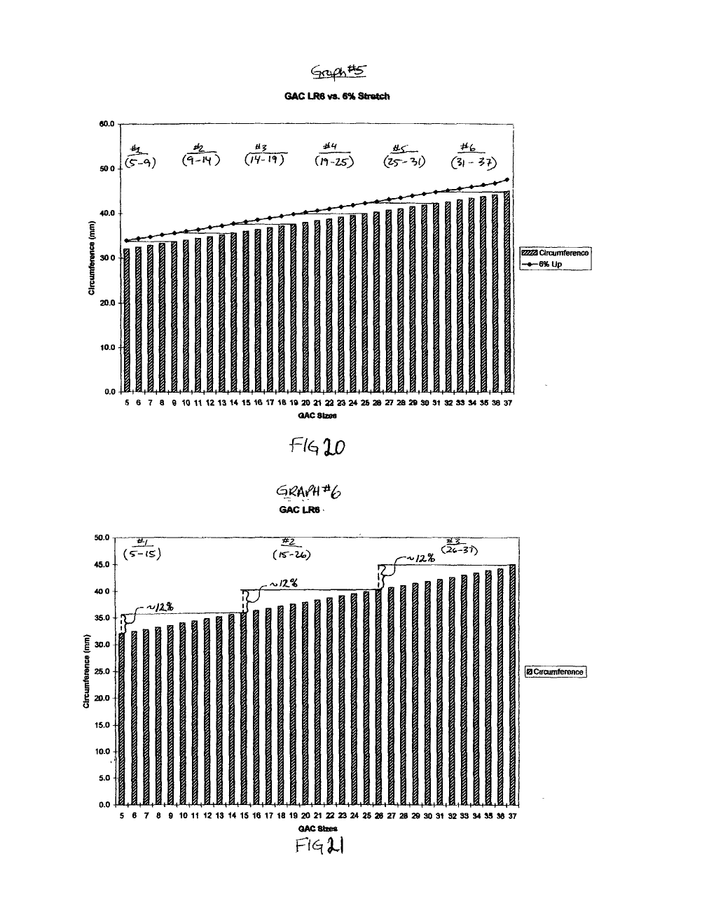

Graph #4 is shown in FIG. 19 and provides yet another summary of band sizes per yet a different set of criteria. Here, the ability to capture the maximum possible range is preserved similar to the criteria for Graph #3. However, the required overlap between ranges is returned to only one common band size between adjacent ranges. The result is only 6 bands in the overall kit, most of which replacing about 6 of the prior conventional GAC bands (except again for the largest band which replaces 5 sizes of the conventional pre-formed bands). However, Graph #4 further shows that this largest band #6 can expand to a greater size than the largest conventional size #37—this is because the ranges were set according to these test criteria by starting at the smallest band size #5 and then iterating the ranges upwards from there.

Graph #5 in FIG. 20 shows the impact on the sizing per a kit of adjustable bands by simply changing the starting point for setting the size ranges from the smallest band to the largest band, and then instead working downward along the sizes to establish the ranges. With only this change in sizing criteria and all other criteria remaining equal, the adjustable band size ranges change substantially. This is seen by comparing Graph #4 of FIG. 19 against Graph #5 in FIG. 20. This Graph #5 shows further importance of monitoring how ranges are set for a given set of sizing capabilities and starting criteria—in particular—in this particular case sizes #3 and #4 of the resulting kit overlap right in the middle of what is observed to be the most common sizes. Therefore, for this reason alone, providing a kit of adjustable bands with ranges more similar to those shown in Graph #4 (FIG. 19) may be preferable to providing such bands working over the ranges shown in Graph #5 (FIG. 20). This is despite the bands having otherwise all the same adjustability per materials and design, and by merely assigning different particular starting values to correspond with the adjustable size ranges.

The previous Graphs #2 to #5 shown in FIGS. 17 to 20 generally provide insight into the different types of kits that may be made using adjustable bands with maximum adjustability that is less than about 8%, and generally less than about 6%. These therefore represent for example kits of adjustable bands made from solid NiTi rings, as the band size ranges correspond to known limits of NiTi as a material. However, the invention contemplates other embodiments described above that are capable of providing wider ranges of size adjustability. These may be formed into kits as well, as follows.

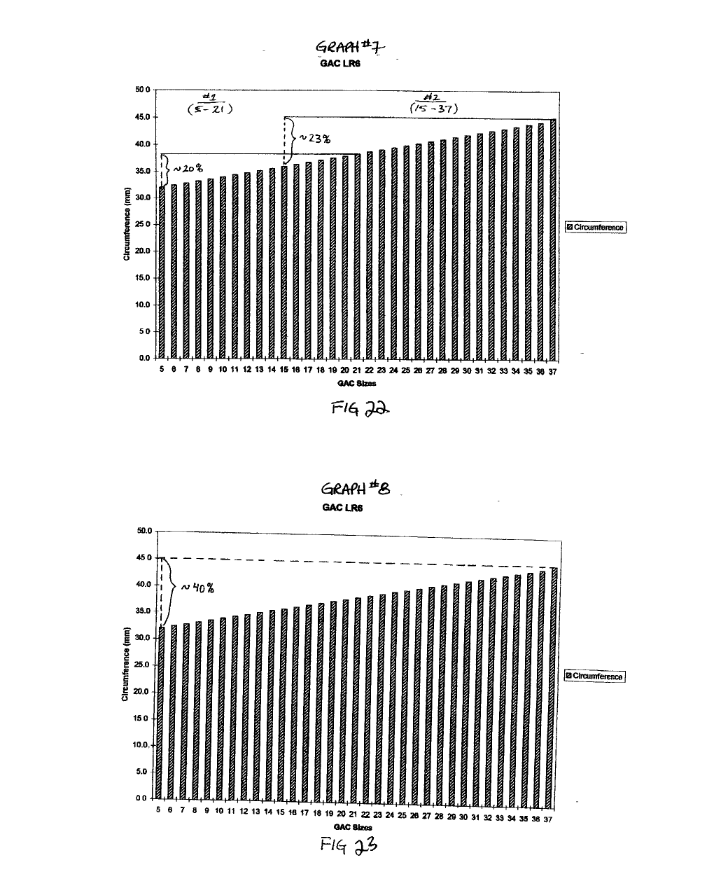

For example, FIG. 21 shows the averaged circumferences for the conventional bands in comparison with a kit of three (3) bands provided according to the invention-band #1 (“Small”), band #2 (“Medium”), and band #3 (“Large”). The criteria for this kit was to provide three bands, each having a range of approximately ⅓ of the overall range otherwise corresponding to the more than thirty conventional bands, and further requiring that conventional size #18 fall within the middle of the Medium range (as what is believed to be the center of the “bell curve” of most frequently used bands). The result is shown, with the Small band #1 replacing conventional sizes 5 to 15, Medium band #2 replacing conventional sizes 15 to 26, and Large band #3 replacing conventional sizes 26 to 37. In general, adjustable bands according to this kit are required to expand/contract over a range of about 12%. Therefore, it follows that bands having adjustability of at least 10%, and still more preferred at least 12% their resting circumference are highly desirable and may be provided according to the present invention.

Notwithstanding the significant benefit of the kit just described, another beneficial kit is also illustrated by way of Graph #7 in FIG. 22 as follows. Here, the criteria for the kit is that two 2) bands be provided to replace all the conventional band sizes measured. In addition, it is required that there be significant overlap between the two adjustable band sizes, preferably the overlap providing choices between the two bands over the most frequently used range of bands between about sizes #15 or 16 and sizes #21 or 22. The result shown in FIG. 22 provides a first band #1 that replaces conventional band sizes #5 to #21, and a second band #2 that replaces conventional band sizes #15 to #37. The first band size is required to change about twenty (20%) percent over its required range, whereas the second band size #2 is required to change about twenty three (23%) percent over its range. These new adjustable band sizes #1 or #2 overlap, and are therefore both useable for, teeth conventionally fitted with GAC band sizes #15 to #21. In one regard, this may provide useful choices as other band dimensions may vary between the smaller new band #1 and the larger new band #2, such as height or wall thickness, two parameters that are observed to also change with changing circumference. More specifically, for the overlap at conventional size #21, the new adjustable band #1 is stretched to its limit—however, it is probably much thinner and may have a shorter vertical height at that amount of circumferential stretch, and this may be desired for the particular tooth and considering other neighboring teeth.

Still further, Graph #8 in FIG. 23 shows an overall range from smallest band #5 to largest band #37 to be about 40% (circumference). Various embodiments of the present invention provide such adjustability, such that one band may truly in fact fit most or even all teeth of the typical patient population seeking orthodontia.

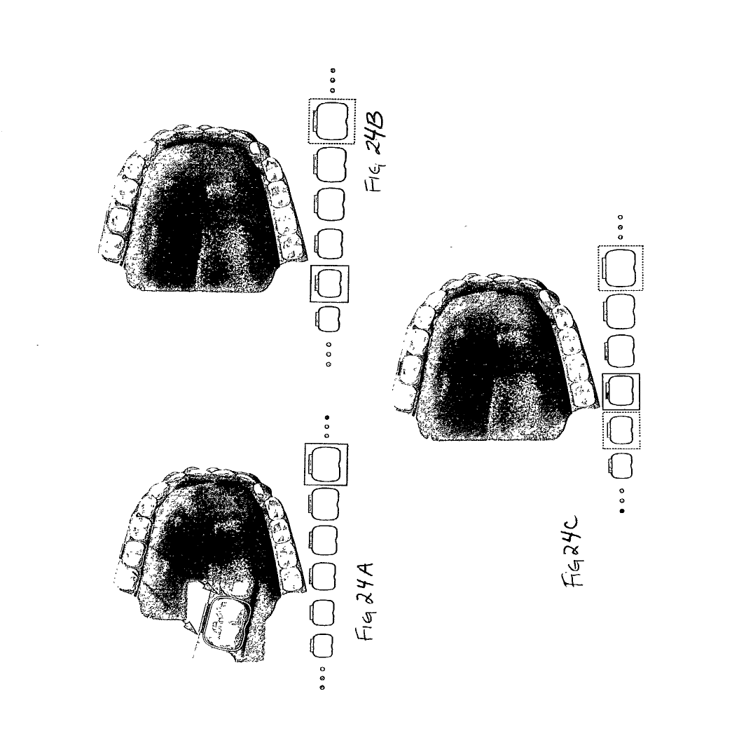

In any event, regardless of the specific ranges identified for a particular kit, significant value is provided by having sufficient adjustable range to replace at least about 5 conventional band sizes. This is because, despite the difference between conventional bands of merely about 1%, trained orthodontic professionals often estimate a tooth size to within about 5 band sizes of the correct size. More specifically, band fitting using conventional techniques and bands typically follows a process similar to the following, and by reference variously to FIGS. 24A-C. As a starting point, a provider will first generally err toward a larger band, as shown schematically in FIG. 24A. This first try typically fails, and the first tried band is either discarded or resterilized and returned to inventory, often even despite damage from the trial effort. Next, as illustrated in FIG. 24B, the provider will often go to the other end of the range, usually within about 5 band sizes down. This often is too small, but closer because the first failure provided some frame of reference for more accurate sizing. Finally, often on the third try, though sometimes even after one or more additional failed attempts, the right band size is found and fit over the tooth. Then, it is removed, cemented, and placed over the tooth again (not shown).

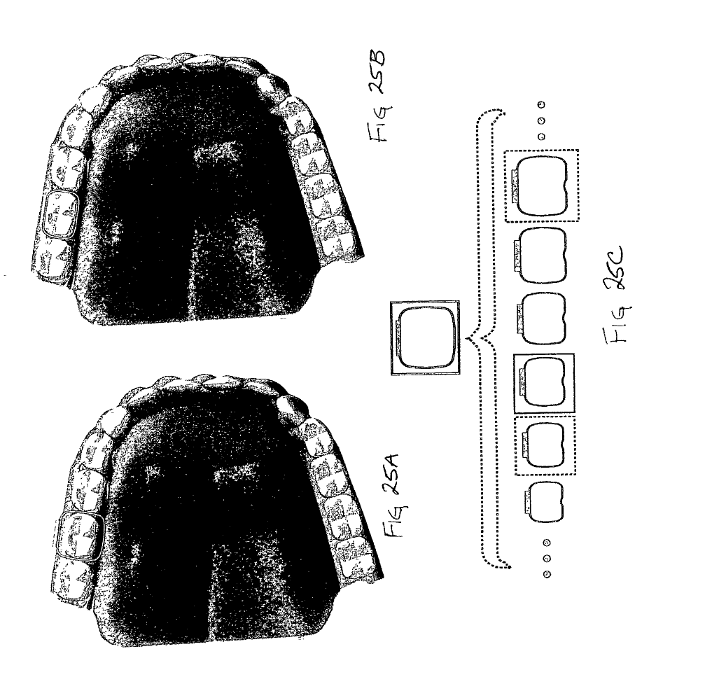

Therefore, an adjustable band that spans the entire range of these other bands, that would normally have been tried using conventional devices, would now instead allow a “first try” band fitting. This is because the band starts at the bigger size, and shrinks down to get to the smaller size, somewhere in between encountering the tooth and making the conformed fit. This is shown schematically in FIGS. 25A-C.

The “first try” fitting process allowed by the present invention is extremely valuable for: patient comfort, time in the chair, limiting wasted inventory, and ease of use for the orthodontic provider. In addition, the confidence that this provides, by removing substantially all failed fitting attempts from the process, also allows for other benefits as follows.

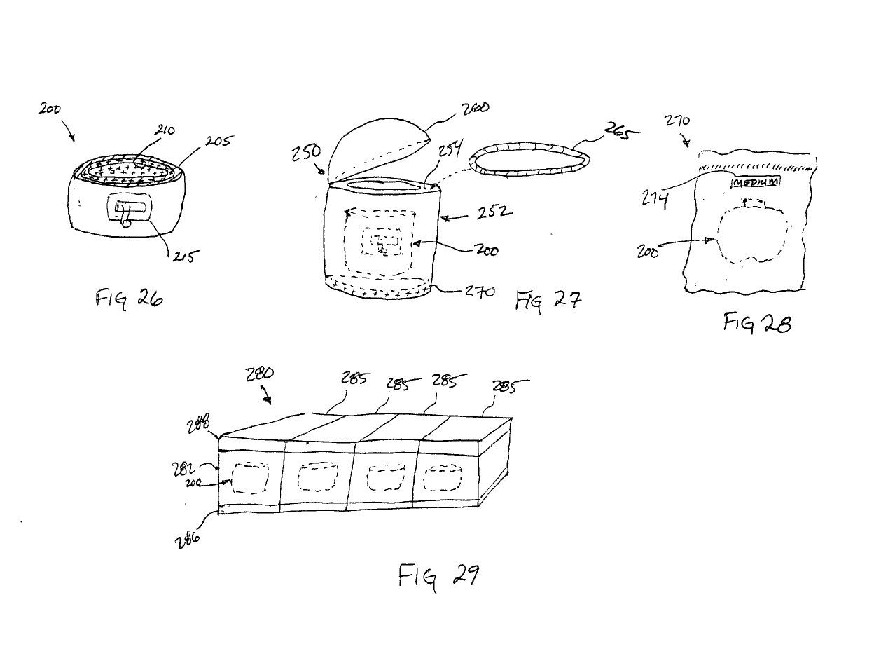

In one regard, bands according to the invention may be “pre-coated” with adhesive cements, and therefore are ready to affix to the tooth on that first try fitting. The step of removing even the correctly fitted tooth is therefore removed because the user knows its right before trying it. An example of a pre-coated adjustable band 200 is shown in FIG. 26, including a buccal attachment 215 for reference, and a coating of adhesive cement 210 on an inner surface of the band 200 to be applied over the outside of at tooth.

As most adhesive cements are curable and therefore environmentally sensitive, such prepared band product may require special packaging. For example, many UV curable cements may degrade by curing ahead of time after prolonged exposure to UV components of ambient light. Such cements, or other types of applicable cements, may also be extremely moisture sensitive, and thus a proper storage container may require protection of a low humidity environment until use.

Thus, one exemplary container 250 is shown for illustration in FIG. 27 and includes a housing 252 containing a pre-coated band 200 with an open top 254 that interfaces with a hinged lid 260. A means for ensuring hermetic seal may be provided, such as by gasket 265 that may sit between lid 260 and housing 252. Container 250 may further contain a means for absorbing humidity within the chamber holding band 200, such as for example a reservoir as shown at reservoir 270 that communicates with interior of housing 252 and includes a humidity absorbing material that may be of many types widely know in the art. In addition, as just described immediately above, the materials for housing 250 may further be chosen or adapted to shield against UV penetration in the event the pre-coated cement is of the UV curable type.

To the extent packages such as that just described may be preferably individualized and disposable, other more simple concepts may be used, such as for example a heat sealed pouch container 270 such as shown in FIG. 28. Pouch 270 contains an individual band 200, and is cut or zipped open to retrieve band 200 therefrom, but thereafter discarded. Indicia may be provided such as shown at size indicia 274, and may indicate size of the band contained (if multiple bands are included), the type of tooth the band is for, type of attachment provided, type of cement adhesive, and/or expiration date. Such bags may also be color coded, such as for example including a kit of four colored containers, each representing one of the following teeth: lower left, lower right, upper left, upper right (e.g. for first molars for example). Or, the color may be more generic to the type of tooth, such as “first molar”.

One container may also be provided that includes multiple such precoated bands, as shown by container 280 in FIG. 29. Such container may include similar elements as shown for container 250 in FIG. 29, including a housing 282, hinged or removable lid 288, and even possibly a lower reservoir 286 for moisture-absorbing material. To the extent the pre-coated adhesive cement is of a type that can withstand reasonable an isolated exposure to ambient atmosphere conditions, this container may have a common lid that seals appropriately between uses. The lid 288 may also have several portions corresponding to several individual compartments 285. For example, each compartment may contain one individual band or several of a particular type or kit of bands. One specific example of a specialized container contains four individual compartments 285, each one corresponding to an adjustable band specific for one of: lower left, lower right, upper left, upper right teeth. This container, even if disposable, is very useful for orthodontic professionals who typically band all four teeth, and in particular where all the bands are pre-coated. In particular, this container is useful where each band is “one size fits all” for the particular type of tooth indicated.

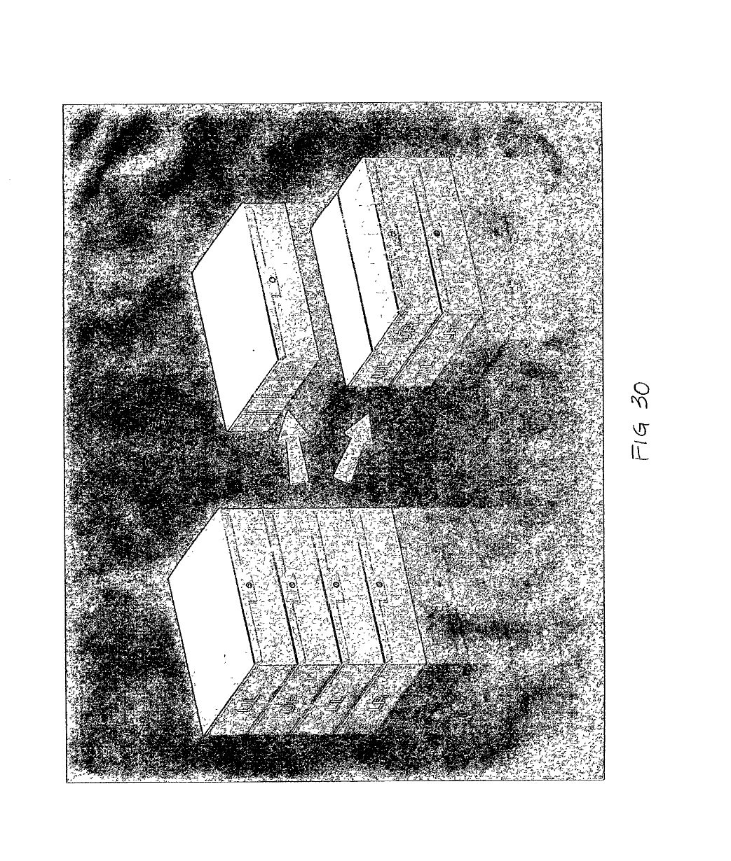

Inventory management in general is simplified by the present invention, as all the many different sizes required by conventional bands are replaced by only a few, and in some cases only one band to fit all sizes, at least for each tooth “type”. In conventional inventories, the many different band sizes are often included in containers, which due to the sheer volumes are often stacked in cupboards or on dedicated counter space. An exemplary stack of such containers used for example for first molar bands are shown in FIG. 30. However, all these containers are significantly unwieldy to keep at patient-side in a typical office performing orthodontia. In many cases, there are tables aside patient chairs that are not even sized to hold even one of the cases, and certainly often not more than one. Therefore, personnel performing the banding often must go back and forth to the inventory, either for each and every band tried, or to switch out the containers between band “types” each time a different tooth is being fitted. Accordingly, by significant reduction in the number of band sizes required, the present invention also allows for more efficient packaging to accommodate the environment of orthodontic lab spaces. More specific illustrative examples are further shown in FIG. 30, such as providing all bands of the following types—lower left (LL), lower right (LR), upper left (UL), and upper right (UR)—in one container of similar size, or perhaps even smaller, as that previously used for more conventional band inventories. This is shown at the top right of FIG. 30. Alternatively, far smaller containers may be used for bands of each type, giving much more space on the table tops next to patients where other tools or devices may be kept related to the banding or other adjunctive procedures.

The various embodiments described above are generally intended for use in overall orthodontic systems intended to be used in cooperation to manipulate the position of teeth in patients. Certain reference is made to specific beneficial applications for the purpose of illustration, but such specified applications are not intended to be limiting. For example, reference to the adjustable bands of the invention is often specified for use as molar bands as the most frequent types of bands used in conventional orthodontia. However, other bands for all teeth may be made according to the various embodiments herein described, including for example: cuspid, bicuspid, central, and lateral bands. In addition, it is also contemplated that, though inventory reduction is a highly beneficial result that the present invention provides, multiple bands with different variations may be provided to meet different types of situations and needs, such as for example bands of varied heights, shapes, contours, wall thicknesses, or having different types of attachments. In addition, the coupling of the bands herein described to other equipment, such as buccal and/or lingual attachments, may be done according to a variety of means known well in the art, such as soldering, welding, gluing, solvent bonding, melt bonding, or the like, despite certain specified exemplary modes being herein described for illustration.

Various modifications may be made to the previously disclosed embodiments above without departing from the scope of the present invention which is intended to be read as broad as possible with regard to the intended objectives described herein and without impinging upon what is already known in the art. Many examples of such modifications have been provided as illustrative and are not intended to be limiting, though significant value may be had in relation to certain such specific modifications or embodiments. Where particular structures, devices, systems, and methods are described as highly beneficial for the primary objective herein to provide adjustable orthodontic bands, other applications are contemplated both in dentistry and otherwise in and out of the body. For example, various of the bands described may be found highly beneficial for use as dental matrix bands in dental matrix forming procedures. Other applications may include adjustable annular collars used to lock down over centrally located devices extending within their bore. Another additional use for further illustration includes use of such a band to graft two adjacent work pieces together, such as in a medical application to attach two pieces of bone together as a bone grafting tool.

The various detailed descriptions of the specific embodiments may be further combined in many differing iterations, and other improvements or modifications may be made that are either equivalent to the structures and methods described or are obvious to one of ordinary skill in the art, without departing from the scope of the invention. The illustrative examples therefore are not intended to be limiting to the scope of the claims appended below, unless such limitation is specifically indicated.

What is claimed is:

1. An orthodontic appliance system, comprising:
an adjustable orthodontic band having an annular body with a top end and a bottom end and a length along a longitudinal axis extending between the top and bottom ends, the annular body further comprising an integral circumferential wall that circumscribes a bore aligned with the longitudinal axis and extending along the length between the top and bottom ends;
wherein the annular body is adjustable between a first configuration and a second configuration such that the bore has an adjustable inner diameter between a first inner diameter in the first configuration and a second inner diameter in the second configuration, the first inner diameter is sufficiently large to receive a patient's tooth within the bore with the annular body positioned loosely around the tooth, and the second inner diameter is substantially less than the first inner diameter such that the annular body is adapted to be secured and retained with a substantially tight fit around the tooth as a semi-permanent implant for use in chronic orthodontia procedures.

2. The system of claim 1, wherein
the wall comprises a material that is adapted to be coupled to a source of energy and to exhibit a material response to energy from the source such that the wall is adjustable between first and second conditions that correspond with the first and second configurations, respectively, of the annular body.

3. The system of claim 2, further comprising:
an energy source that is adapted to couple to the material and to apply sufficient energy to the material to adjust the wall between the first and second conditions.

4. The system of claim 3, further comprising:
a coupling tool comprising a conductor that is adapted to couple to the energy source and also to the material such that energy from the applied energy source is coupled to the material via the conductor.

5. The system of claim 2, wherein the wall is adjusted from the first condition to the second condition when the material exhibits the material response to the energy from the source.

6. The system of claim 2, wherein the wall is adjusted from the second condition to the first condition when the material exhibits the material response to the energy from the source.

7. The system of claim 2, wherein the material exhibits the material response to a change of temperature between a first temperature and a second temperature such that the wall is adjusted between the first and second conditions, respectively.

8. The system of claim 7, wherein the first temperature is greater than the second temperature.

9. The system of claim 7, wherein the second temperature is greater than the first temperature.

10. The system of claim 7, wherein
the material comprises a thermal conductor that is adapted to be thermally coupled to a source of thermal energy such that the thermal energy flows between the source and the thermal conductor in order to heat the material and thereby adjust the temperature of the material between the first and second temperatures.

11. The system of claim 10, further comprising:
a thermal energy source that is adapted to be thermally coupled to the thermal conductor and to heat the material and thereby adjust the temperature of the material between the first and second temperatures.

12. The system of claim 11, further comprising:
a thermal coupling tool that is adapted to thermally couple the thermal energy source to the thermal conductor.

13. The system of claim 10, further comprising:
a cryogenic cooling source that is adapted to be thermally coupled to the thermal conductor and to actively cool the material in order to adjust the material between the first and second temperatures.

14. The system of claim 13, wherein
the cryogenic cooling source is adapted to actively cool the thermal conductor to thereby adjust the material to an actively cooled condition that corresponds to one of the first and second temperatures and that is below a physiologic body temperature within the patient's mouth and;
the other of the first and second temperatures corresponds to the physiologic body temperature within the patient's mouth; and
the material is adapted to be adjusted from the actively cooled condition to the other of the first and second temperatures by passive heat transfer within the patient's mouth.

15. The system of claim 14, wherein the actively cooled condition corresponds to the first temperature.

16. The system of claim 15, wherein the actively cooled condition corresponds to the second temperature.

17. The system of claim 13, further comprising:
a cryogenic coupling tool that is adapted to thermally couple the cryogenic cooling source to the thermal conductor

18. The system of claim 7, wherein the material comprises an electrical conductor that is adapted to be electrically coupled to a source of electrical energy and to conduct electrical current from the source and also to heat in response to said electrical current such that the temperature is changed between the first and second temperatures.

19. The system of claim 18, further comprising:
an electrical current source that is adapted to be electrically coupled to the material in order to form an electrical circuit that includes the material and to supply a sufficient amount of electrical current through the material to heat the material and thereby adjust the material between the first and second temperatures.

20. The system of claim 19, further comprising:
an electrical coupling tool that is adapted to electrically couple the electrical current source to the electrical conductor in order to form the electrical circuit.

21. The system of claim 7, wherein the material is adapted to be coupled to a source of sonic energy and to heat in response to sonic energy from the source such that the temperature is changed between the first and second temperatures.

22. The system of claim 21, further comprising:
a sonic energy source that is adapted to be sonically coupled to the material and supply sonic energy to the material in order to change the temperature between the first and second temperatures.

23. The system of claim 22, further comprising:
a sonic coupling tool that is adapted to sonically couple the sonic energy source to the material.

24. The system of claim 7, wherein the material is adapted to couple to a source of light energy and to heat in response to the light energy such that the temperature is changed between the first and second temperatures.

25. The system of claim 24, further comprising:
a light source which is adapted to be optically coupled to the material and thereby apply light energy to the material in order to change the temperature between the first and second temperatures.

26. The system of claim 25, further comprising:
a light coupling tool that is adapted to optically couple the light source to the material.

27. The system of claim 7, wherein
the material comprises a shape memory material;
in the first condition the wall has a first shape; and
in the second condition the wall has a second shape.

28. The system of claim 27, wherein the shape memory material comprises a metal.

29. The system of claim 27, wherein the shape memory material comprises titanium.

30. The system of claim 27, wherein the shape memory material comprises a shape memory alloy.

31. The system of claim 30, wherein the shape memory alloy comprises titanium and at least one other metal.

32. The system of claim 31, wherein the at least one other metal comprises nickel.

33. The system of claim 27, wherein the wall comprises at least one void through which the bore communicates externally through the wall between the top and bottom ends.

34. The system of claim 33, wherein the wall further comprises a plurality of struts that define said at least one void, and the material is located at least in part along the struts.

35. The system of claim 34, further comprising a plurality of said voids that are discontinuous and distinct and that are separated by said plurality of struts.

36. The system of claim 34, wherein the struts have relative positions within the wall and that change as the material is adjusted between the first and second temperatures, such that at the first temperature the struts have relative positions that define a first pattern corresponding to the first shape, and such that at the second temperature the struts and have relative positions that define a second pattern different from the first pattern and corresponding to the second shape.

37. The system of claim 36, wherein each of the plurality of struts comprises an elongate member along a strut axis, and wherein the strut axis is adjusted relative to the longitudinal axis when the wall is adjusted between the first and second shapes.

38. The system of claim 37, wherein each strut axis defines an acute angle relative to the longitudinal axis, and the acute angle is reduced when the wall is adjusted from the first shape to the second shape.

39. The system of claim 37, wherein the wall further comprises a plurality of bridges, and each bridge extends between adjacent struts along a bridge axis that is different than the strut axis of the respective adjacent struts.

40. The system of claim 39, wherein the bridges are integral with the struts.

41. The system of claim 40, wherein the material is located at least in part along the bridges.

42. The system of claim 27, wherein the wall has a first circumference corresponding to the first shape and a second circumference corresponding to the second shape.

43. The system of claim 42, wherein the wall has a wall thickness that does not substantially change at any location along the circumference as the wall is adjusted between the first and second shapes.

44. The system of claim 27, wherein the shape memory material exhibits a one-way shape memory response when the material is adjusted from one of the first and second temperatures to the other of the first and second temperatures.

45. The system of claim 44, wherein the shape memory material exhibits a one-way shape memory response when the material is adjusted from the first temperature to the second temperature.

46. The system of claim 44, wherein the shape memory material exhibits a one-way shape memory response when the material is adjusted from the second temperature to the first temperature.

47. The system of claim 27, wherein the shape memory material exhibits a two-way shape memory response when the material is adjusted between the first and second temperatures, respectively.

48. The system of claim 1, wherein the annular body is adjustable between the first and second configurations without substantial plastic deformation of the wall.

49. The system of claim 48, wherein the wall comprises an elastic material that exhibits elastic deformation between the first and second configurations.

50. The system of claim 48, wherein the wall comprises a superelastic material that exhibits a superelastic deformation when the wall is adjusted between the first and second conditions.

51. The system of claim 50, wherein the superelastic material comprises a metal or metal alloy.

52. The system of claim 50, wherein the superelastic material comprises titanium.

53. The system of claim 50, wherein the superelastic material comprises an alloy of the titanium and at least one other metal.

54. The system of claim 53, wherein the at least one other metal comprises nickel.

55. The system of claim 50, wherein
the superelastic material is adjustable with force from a memory condition to a deformed condition, and is adapted to recover from the deformed condition to the memory condition by superelastic recovery;
in the first configuration the superelastic material is in the deformed condition; and
the annular body is adjustable from the first configuration to the second configuration by superelastic recovery of the superelastic material toward the memory condition.

56. The system of claim 55, further comprising:
an adjusting tool that is adapted to engage the wall and superelastically deform the superelastic material to the deformed condition to thereby adjust the wall to the first condition in order to place the annular body in the first configuration around the patient's tooth, and which is further adapted to release the wall to allow for the elastic recovery of the superelastic material so that the wall is adjusted to the second condition corresponding to the second configuration of the annular body.

57. The system of claim 1, wherein the inner diameter of the bore is adjustable substantially along the entire length of the annular body.

58. The system of claim 1, wherein the annular body in the second configuration is adapted to substantially conform to the patient's tooth.

59. The system of claim 1, wherein the annular body has a coupler region that is adapted to be secured to a coupler for interacting with a force bearing orthodontic appliance.

60. The system of claim 59, wherein the wall along the coupler region does not have a substantially adjustable shape when the annular body is being adjusted between the first and second configurations.

61. The system of claim 59, wherein the adjustable orthodontic band further comprises:
a coupler secured to the annular body and that is adapted to interact with a force-bearing orthodontic appliance.

62. The system of claim 61, wherein the coupler is integral with the annular body.

63. The system of claim 61, wherein the coupler is soldered to the annular body.

64. The system of claim 61, wherein the coupler is brazed to the annular body.

65. The system of claim 61, wherein the coupler is mechanically secured to the annular body.

66. The system of claim 61, wherein the coupler is adhesively bonded to the annular body.

67. The system of claim 59, wherein the coupler comprises a bracket assembly.

68. The system of claim 59, wherein the coupler comprises a tubular member with a passageway along an axis that is transverse to the longitudinal axis that is adapted to receive an orthodontic archwire.

69. The system of claim 1, wherein the annular body further comprises an insulator that comprises a different material than the wall and that covers at least a portion of the wall.

70. The system of claim 69, wherein the insulator is secured to the wall.

71. The system of claim 69, wherein the insulator comprises a tubular wall that is positioned adjacent to the wall.

72. The system of claim 69, wherein the wall comprises inner and outer surfaces relative to the bore, and the insulator covers at least a portion of the inner surface.

73. The system of claim 69, wherein the wall comprises inner and outer surfaces relative to the bore, and the insulator covers at least a portion of the outer surface.

74. The system of claim 69, wherein the insulator covers a sufficient portion of the wall such that wall is not substantially exposed to the environment of the patient's mouth when the band is secured and retained on the tooth as a semi-permanent implant.

75. The system of claim 74, wherein
the wall comprises an electrically conductive material;
the insulator comprises an electrical insulator and covers a substantial portion of the wall sufficient to expose the electrically conductive material for electrical coupling to an external electrical energy source but also to substantially isolate current from the source to flow substantially through the electrically conductive material without substantial leakage into electrically conductive structures within the patient's mouth.

76. The system of claim 74, wherein
the wall comprises a thermally conductive material;
the insulator comprises a thermal insulator and covers a substantial portion of the wall sufficient to expose the thermally conductive material for coupling to an external energy source in order to heat the thermally conductive material but also to substantially isolate the thermally conductive material from substantially heating adjacent structures within the patient's mouth.

77. The system of claim 69, wherein
the wall comprises at least one void through which the bore communicates externally of the wall between the top and bottom ends; and
the insulator substantially covers the at least one void to prevent communication of the bore externally of the elongate body through the at least one void.

78. The system of claim 77, wherein
the wall comprises a plurality of said voids; and
the insulator is located to substantially block communication of the bore externally of the elongate body through any one of the voids.

79. The system of claim 78, wherein the insulator is located within each of the voids within the wall.

80. The system of claim 78, wherein the wall has inner and outer surfaces relative to the bore, and the insulator is secured to the outer surface of the wall and covers the voids such that the voids are substantially exposed to the bore but are prevented from communication with the environment of the mouth externally of the annular body.

81. The system of claim 69, wherein the insulator comprises an elastic material.

82. The system of claim 69, wherein the insulator comprises a non-metal material.

83. The system of claim 69, wherein the insulator comprises an elastomeric polymer.

84. The system of claim 69, further comprising a tie layer between the insulator and the wall and that comprises a material that is adapted to secure the insulator in a substantially fixed position relative to the wall.

85. The system of claim 1, wherein the system further comprises a kit of no more than 8 of said bands that are adapted to fit varied teeth over a range of at least about 30% circumference difference.

86. An orthodontic appliance system, comprising:
an adjustable orthodontic band having an annular body with a top end and a bottom end and a length along a longitudinal axis extending between the top and bottom ends, the annular body further comprising a circumferential wall that circumscribes a bore aligned with the longitudinal axis and extending along the length between the top and bottom ends;
wherein the annular body is adjustable between a first configuration and a second configuration as a result of a material response of the wall to applied energy from an energy source, such that the bore has an adjustable inner diameter between a first inner diameter in the first configuration and a second inner diameter in the second configuration, and in at least one of the first and second configurations the bore is adapted to house the patient's tooth with the annular body secured and retained with a substantially tight fit around the tooth such that the band may be worn as a semi-permanent implant on the tooth for use in chronic orthodontia procedures.

87. The system of claim 86, wherein the adjustable orthodontic band is pre-coated with an adhesive cement and is provided individually pre-packaged within a disposable container.

88. An adjustable orthodontic band, comprising:
an annular body with a top end, a bottom end, a height along a longitudinal axis extending between the top and bottom ends, and a wall that circumscribes a bore aligned with the longitudinal axis and extending along the height between the top and bottom ends, the wall comprising a metal alloy that is characterized as at least one of superelastic or shape memory characteristics;
wherein the annular body is adapted to be secured to and retained with a substantially tight fit around the tooth with the tooth located at least in part within the bore and is adapted to be worn as a semi-permanent implant on the tooth for use in chronic orthodontia procedures.

89. The implant of claim 88, wherein the annular body is pre-coated with an adhesive cement and is provided individually pre-packaged within a disposable container.

90. An orthodontic band, comprising:
an annular body with a top end, a bottom end, a height along a longitudinal axis extending between the top and bottom ends, and a wall that circumscribes a bore aligned with the longitudinal axis and extending along the height between the top and bottom ends, the wall comprising a material that exhibits at least one of superelastic or shape memory characteristics;
wherein the annular body is adapted to be secured to and retained with a substantially tight fit around the tooth with the tooth located at least in part within the bore and is adapted to be worn as a semi-permanent implant on the tooth for use in chronic orthodontia procedures.

91. The band of claim 90, wherein the material comprises a metal alloy.

92. The band of claim 90, wherein the material comprises a shape memory material.

93. The band of claim 92, wherein the shape memory material comprises a shape memory metal alloy.

94. The band of claim 93, wherein the shape memory metal alloy comprises titanium.

95. The band of claim 93, wherein the shape memory metal alloy comprises nickel.

96. The band of claim 93, wherein the shape memory metal alloy comprises nickel and titanium.

97. The band of claim 96, wherein the nickel and titanium are present in the alloy in an equiatomic relationship.

98. The band of claim 90, wherein the material comprises a superelastic material.

99. The band of claim 98, wherein the superelastic material comprises a superelastic metal alloy.

100. The band of claim 99, wherein the superelastic metal alloy comprises titanium.

101. The band of claim 99, wherein the superelastic metal alloy comprises nickel.

102. The band of claim 99, wherein the superelastic metal alloy comprises nickel and titanium.

103. The band of claim 102, wherein the nickel and titanium are present in the superelastic metal alloy in an equiatomic relationship.

104. The band of claim 90, wherein the annular body is adjustable without substantially experiencing plastic deformation between a first configuration having a first inner diameter and a second configuration having a second inner diameter that is substantially less than the first inner diameter, and wherein the band is adapted to be secured to and worn around a tooth in one of the first and second configurations, but is not suitably adapted to be secured to and worn around the tooth in the other of the first and second configurations.

105. The implant of any one of claims 90, wherein the adjustable orthodontic band is pre-coated with an adhesive cement and is provided individually pre-packaged within a disposable container.

106. A medical device implant, comprising:
a tubular member having a first end, a second end, a longitudinal axis between the first and second ends, and a wall circumscribing a bore aligned with the longitudinal axis and extending between the first and second ends;
wherein the tubular member is adjustable between a first configuration and a second configuration, in the first configuration the bore has a first inner diameter and the member is adapted to be delivered into the body at a first location, and in the second configuration the bore has a second inner diameter that is less than the first inner diameter, and wherein the tubular member is adapted to be implanted at the location in the second configuration.

107. The implant of claim 106, wherein the tubular member is substantially annular with a height between the first and second ends that is less than the diameter of the bore transverse to the longitudinal axis.

108. The implant of claim 106, wherein the tubular member is pre-coated with an adhesive cement and is provided individually pre-packaged within a disposable container.

109. A dental band that is adapted to be worn around a tooth of a patient, comprising:
an annular body having a circumferential wall that circumscribes a bore that extends along a longitudinal axis, wherein the body is adapted to receive a tooth within the bore and the wall is adapted to be secured around the tooth; and
a coupler assembly attached to the body that is adapted to engage a force bearing member within the mouth of the patient,
wherein the circumferential wall comprises a material that exhibits greater than about 3% elongation before experiencing plastic deformation.

110. The band of claim 109, wherein the material exhibits greater than about 5% elongation before experiencing plastic deformation.

111. The band of claim 109, wherein the material exhibits between about 3% and about 10% elongation prior to experiencing plastic deformation.

112. The band of claim 111, wherein the material exhibits substantially non-plastic deformation for elongation up to at least about 3% elongation, and experiences at least one of substantial plastic deformation or yield failure for elongation of greater than about 10% elongation.

113. The band of claim 109, wherein the annular body is pre-coated with an adhesive cement and is provided individually pre-packaged within a disposable container.

114. A dental band, comprising:
an annular body having a circumferential wall that circumscribes a bore that extends along a longitudinal axis between first and second ends, wherein the body is adapted to receive a tooth within the bore and the wall is adapted to be secured around the tooth, and the circumferential wall comprises at least one substantially solid strut that is bordered by at least one void region through the wall and through which the bore communicates externally of the body between the first and second ends; and
a coupler assembly attached to the body that is adapted to engage a force bearing member within the mouth of the patient.

115. The band of claim 114, wherein the annular body is pre-coated with an adhesive cement and is provided individually pre-packaged within a disposable container.

116. A method for securing an annular body as an implant around an anatomical structure of a patient, comprising:
providing the annular body in a first configuration having a first inner diameter;
adjusting the annular body from the first configuration to a second configuration having a second inner diameter that is substantially less than the first inner diameter; and
positioning the annular body around the anatomical structure and securing the annular body around the anatomical structure in one of the first or second configurations,
wherein the adjusting of the annular body between the first and second configurations assists the positioning and securing of the annular body around the anatomical structure.

117. The method of claim 116, further comprising pre-coating the annular body with an adhesive cement and providing the pre-coated assembly individually pre-packaged within a disposable container.

118. A system for securing an annular body around an anatomical structure associated with a body of a patient, comprising:
an annular body;
means for positioning the annular body around the anatomical structure;
means for securing the annular body to and around the anatomical structure; and
means for engaging the annular body to a force-applying member.

119. The system of claim 118, wherein the means for securing further comprises means for providing the annular body with a coating of adhesive cement and within an individually pre-packaged container.

120. An orthodontic band system, comprising:
an orthodontic band;
an orthodontic attachment secured to the orthodontic band;
a sealed, disposable package; and
wherein the orthodontic band with the secured orthodontic attachment is provided individually packaged within the sealed, disposable package.

121. The adjustable orthodontic band system of claim 120, further comprising:
a moisture absorbing material coupled to an interior space within the package housing the orthodontic band.

122. The system of claim 120, wherein:
the package is adapted to substantially prevent UV light from entering the package.

122. The system of claim 120, further comprising:
a curable cement pre-coated onto an interior surface of the orthodontic band.

123. The system of claim 120, wherein:
the orthodontic band has an adjustable circumference and is adapted to be fit over different teeth having respective circumferences that differ by at least five percent.

124. The system of claim 120, further comprising:
a kit comprising a plurality of said pre-packaged bands;
wherein the orthodontic band of each of the plurality of pre-packaged band assemblies has an adjustable circumference over a unique range of circumferences relative to the other bands of the kit, each range spanning at least 5% difference in circumference.

125. The system of claim 120, wherein:
the package comprises a pouch with a substantially pliable wall.

126. The system of claim 120, further comprising:
indicia located on the package indicating at least one parameter of the orthodontic band contained therein.

127. The system of claim 126, wherein the indicia comprises:
information related to at least one of band type, band size, size range of adjustability, or attachment type.

128. An adjustable orthodontic band system, comprising:
a kit comprising a plurality of adjustable orthodontic bands;
wherein each adjustable orthodontic band of the kit is adjustable over a range of circumferences that varies by at least 5%; and
wherein a substantial portion of each of the respective ranges is unique with respect to the other ranges for the other respective bands.

129. The system of claim 128, wherein:
each of the respective ranges related to one of the bands overlaps with at least one adjacent range corresponding to another of the bands by an overlapping range that spans at least a 1% difference in circumference.

129. The system of claim 128, wherein:
at least one of the bands is adjustable over a range of circumferences that varies by at least 10%.

130. The system of claim 128, wherein:
at least one of the bands is adjustable over a range of circumferences that varies by at least 15%.

131. The system of claim 128, wherein:
at least one of the bands is adjustable over a range of circumferences that varies by at least 20%.

132. The system of claim 128, wherein:
the ranges together cover an overall range of circumference corresponding to at least a 30% circumferential difference.

133. The system of claim 132, wherein:
the kit comprises no more than about 8 uniquely sized bands.

134. The system of claim 132, wherein:
the kit comprises no more than about 7 uniquely sized bands.

135. The system of claim 132, wherein:
the kit comprises no more than about 6 uniquely sized bands.

136. The system of claim 132, wherein:
the kit comprises no more than about 5 uniquely sized bands.

137. The system of claim 132, wherein:
the kit comprises no more than about 4 uniquely sized bands.

138. The system of claim 132, wherein:
the kit comprises no more than about 3 uniquely sized bands.

139. The system of claim 132, wherein:
the kit comprises no more than about 2 uniquely sized bands.

140. The system of claim 128, wherein:
each of the bands is provided pre-coated with an adhesive cement.

141. A method for providing an appropriately sized orthodontic band from a kit of multiple, different sized bands for banding a tooth of a patient, comprising:
comparing an estimated size of the tooth against a plurality of size ranges wherein each size range represents a range of adjustability for a corresponding one of the bands in the kit; and
choosing the orthodontic band that corresponds to at least one of the ranges within which the estimated size of the tooth falls.

142. A method for securing a pre-coated band onto a tooth of a patient, comprising:
providing a plurality of adjustable orthodontic bands that are each pre-coated with an adhesive cement;
choosing a first one of the orthodontic bands; and
securing the first orthodontic band to the tooth of the patient using the adhesive cement.

143. An orthodontic band actuator system, comprising:
an energy source that is adapted to apply energy to an adhesive cement to cure the cement and bond an orthodontic band to a tooth in a patient; and
a heat source that is adapted to apply heat to the orthodontic band sufficient to cause a heat memory response in the band to adjust the band's size downward over the tooth.

144. The system of claim 143, wherein:
the energy source and heat source comprise respective applicators that are integrated into a common nozzle that may be pointed at the tooth.

145. The system of claim 143, wherein:
the energy source and heat source each comprises a respective drive assembly; and
the respective drive assemblies are integrated into a common actuator assembly.
